(19) United States
(12) Patent Application Publication
(10) Pub. No.: US 2010/0033579 A1
(43) Pub. Date: Feb. 11, 2010

(54) Image Shooting Device And Image Playback Device

(75) Inventors: Masahiro YOKOHATA, Osaka (JP); Hideto FUJITA, Osaka (JP); Clarissa LEUNG, Port Coquitlam (CA)

Correspondence Address: NDQ&M WATCHSTONE LLP, 1300 EYE STREET, NW, SUITE 1000 WEST TOWER, WASHINGTON, DC, 20005, US

(73) Assignee: Sanyo Electric Co., Ltd., Osaka (JP)

(21) Appl. No.: 12/471,859

(22) Filed: May 26, 2009

(30) Foreign Application Priority Data
May 26, 2008 (JP) 2008-136986
Apr. 8, 2009 (JP) 2009-093571

(51) Int. Cl. H04N 5/225

(52) U.S. Cl. 348/169; 348/E05.024

(57) ABSTRACT

An image shooting device includes: an image sensing device that, by sequential shooting, outputs a signal representing a series of shot images; a tracking processing portion that, based on the output signal of the image sensing device, sequentially detects the position of a tracking target on the series of shot images and thereby tracks the tracking target on the series of shot images; a clipping processing portion that, for each shot image, based on the detected position, sets a clipping region in the shot image and extracts the image within the clipping region as a clipped image or outputs clipping information indicating the position and extent of the clipping region; and a tracking evaluation portion that, based on the output signal of the image sensing device, evaluates the degree of reliability or ease of tracking by the tracking processing portion. The clipping processing portion varies the extent of the clipping region in accordance with the evaluated degree.

This nonprovisional application claims priority under 35 U.S.C. §119(a) on Patent Application No. 2008-136986 filed in Japan on May 26, 2008 and Patent Application No. 2009-093571 filed in Japan on Apr. 8, 2009, the entire contents of which are hereby incorporated by reference.

### BACKGROUND OF THE INVENTION

1. Field of the Invention

The present invention relates to an image shooting device capable of shooting a moving image. The present invention also relates to an image playback device that plays back a moving image.

2. Description of Related Art

A function of extracting and tracking a moving object is realized in a system employing a surveillance camera. In this type of system, when a moving object (a suspicious person) is detected within a specified area in an image obtained from a surveillance camera, an alarm is outputted. There has also been put into practical use a system furnished with a function of displaying the result of tracking for easy recognition by surveillance staff.

Image-based tracking processing is achieved, for example, by pattern matching—i.e., first setting a tracking pattern and then locating the pattern within images—, or by a method relying on detection of the position of a moving object based on an optical flow, or by a method relying on tracking of a characteristic, such as color, of a subject.

Image processing-based technologies for extracting and tracking a moving object have originally been studied for the purposes of application in surveillance cameras and realization of robot vision, and have recently started to find application in digital cameras for general consumers. For example, there has been disclosed a method of tracking a specified subject and then, by clipping processing, cutting the subject out of a shot image for presentation in a composition fit for the subject of interest.

By performing tracking processing with a main subject taken as the tracking target, and then cutting out of a shot image an image region including the image of the tracking target, it is possible to offer a user a moving image with a composition good for the tracking target. However, image processing-based tracking does not always succeed: various factors cause the ease of tracking to change, often causing a camera to lose track of the tracking target. For example, in a case where tracking is performed based on color information of a tracking target, if the color of the background is similar to that of the tracking target, the ease of tracking may be so low as to cause a camera to lose track of the tracking target. As the ease of tracking lowers, naturally the reliability of tracking lowers.

As shown in FIG. 30A, in a state where the reliability or ease of tracking is high, it is possible to set within a shot image 901a clipping region 902 with a tracking target 900 taken as of interest, and generate and record the image within the clipping region 902 as a clipped image. However, in a state where the reliability or ease of tracking is low, if tracking processing is performed likewise as in a state where it is high, as shown in FIG. 30B, it may occur that a tracking target 910 is not located in a clipping region 912 set within a shot image 911. FIG. 30B assumes a case where, during execution of tracking processing based on color information, an object of a color similar to the color of a tracking target is present in the background, and that object is erroneously recognized as the tracking target.

It is an extremely undesirable situation that, although a main subject as a tracking target appears within the shooting region of a camera, the image of the main subject does not appear in the clipped image recorded in the camera. Such situations, therefore, should be prevented as much as possible.

While the problem encountered when one adopts clipping processing with a tracking target taken as of interest (that is, in electronic zooming) has been discussed above, a similar problem can occur when one performs optical zooming with a tracking target taken as of interest. A similar problem can occur also when one attempts to perform processing that is to be performed in time of shooting instead in time of image playback. A similar problem can occur even when one attempts to realize automatic focusing or the like with a tracking target taken as of interest.

Incidentally, there have been proposed a variety of technologies aimed at acquiring an image with tracking target taken as of interest by use of electronic zooming and/or optical zooming. Actually, however, none of the conventional technologies gives consideration to the reliability or ease of tracking. There has also been proposed a technology for moving the region used for automatic focusing in accordance with movement of a tracking target in an image. Again, however, this technology does not give consideration to the reliability or ease of tracking.

### SUMMARY OF THE INVENTION

A first image shooting device according to the present invention is provided with: an image sensing device that, by sequential shooting, outputs a signal representing a series of shot images; a tracking processing portion that, based on the output signal of the image sensing device, sequentially detects the position of a tracking target on the series of shot images and thereby tracks the tracking target on the series of shot images; a clipping processing portion that, for each shot image, based on the detected position, sets a clipping region in the shot image and extracts the image within the clipping region as a clipped image or outputs clipping information indicating the position and extent of the clipping region; and a tracking evaluation portion that, based on the output signal of the image sensing device, evaluates the degree of reliability or ease of tracking by the tracking processing portion. Here, the clipping processing portion varies the extent of the clipping region in accordance with the evaluated degree.

Specifically, for example, the clipping processing portion makes the extent of the clipping region smaller when the degree is evaluated to be comparatively high than when the degree is evaluated to be comparatively low.

Specifically, for example, the clipping processing portion sets the extent of the clipping region based on the evaluated degree and extent of the tracking target on the shot image.

Specifically, for example, the tracking evaluation portion receives one of the series of shot images as a calculation target image, divides the entire region of the calculation target image into a tracking target region where the tracking target appears and a background region other than the tracking target region, and evaluates the degree by comparison of an image characteristic in the tracking target region with an image characteristic in the background region.

A second image shooting device according to the present invention is provided with: an image sensing device that, by sequential shooting, outputs a signal representing a series of shot images; a tracking processing portion that, based on the output signal of the image sensing device, sequentially detects the position of a tracking target on the series of shot images and thereby tracks the tracking target on the series of shot images; an angle-of-view adjustment portion that adjusts the angle of view in shooting; and a tracking evaluation portion that, based on the output signal of the image sensing device, evaluates the degree of reliability or ease of tracking by the tracking processing portion. Here, the angle-of-view adjustment portion varies the angle of view in accordance with the evaluated degree.

Specifically, for example, the angle-of-view adjustment portion adjusts the angle of view in accordance with the degree such that, when the degree is evaluated to be comparatively high, the extent of the tracking target on the shot image is comparatively large and, when the degree is evaluated to be comparatively low, the extent of the tracking target on the shot image is comparatively small.

Specifically, for example, the angle-of-view adjustment portion sets the angle of view based on the evaluated degree and the extent of the tracking target on the shot image.

Specifically, for example, the tracking evaluation portion receives one of the series of shot images as a calculation target image, divides the entire region of the calculation target image into a tracking target region where the tracking target appears and a background region other than the tracking target region, and evaluates the degree by comparison of an image characteristic in the tracking target region with an image characteristic in the background region.

A first image playback device according to the present invention is provided with: an image acquisition portion that, by reading from a recording portion an image signal obtained by sequential shooting of a subject, acquires a series of input images based on the image signal; a tracking processing portion that, based on the image signal of the series of input images, sequentially detects the position of a tracking target on the series of input images and thereby tracks the tracking target on the series of input images; a clipping processing portion that, for each input image, based on the detected position, sets a clipping region in the input image and extracts the image within the clipping region as a clipped image; and a tracking evaluation portion that, based on the image signal of the series of input images, evaluates the degree of reliability or ease of tracking by the tracking processing portion. The image playback device outputs the image signal of a series of clipped images to a display portion or to outside. Here, the clipping processing portion varies the extent of the clipping region in accordance with the evaluated degree.

A third image shooting device according to the present invention is provided with: an image sensing device that, by sequential shooting, outputs a signal representing a series of shot images; a tracking processing portion that, based on the output signal of the image sensing device, sequentially detects the position of a tracking target on the series of shot images and thereby tracks the tracking target on the series of shot images; a region setting portion that, based on the detected position, sets an evaluation value collection region within each shot image; an acquisition condition control portion that, based on the image signal within the evaluation value collection region in each shot image, controls a condition for acquisition of the series of shot images; and a tracking evaluation portion that, based on the output signal of the image sensing device, evaluates the degree of reliability or ease of tracking by the tracking processing portion. Here, the region setting portion varies the extent of the evaluation value collection region in accordance with the evaluated degree.

A second image playback device according to the present invention is provided with: an image acquisition portion that, by reading from a recording portion an image signal obtained by sequential shooting of a subject, acquires a series of input images based on the image signal; a tracking processing portion that, based on the image signal of the series of input images, sequentially detects the position of a tracking target on the series of input images and thereby tracks the tracking target on the series of input images; a region setting portion that, based on the detected position, sets an evaluation value collection region within each input image; an output image generation portion that, based on the image signal within the evaluation value collection region of each input image, retouches the series of input images to generate a series of output images; and a tracking evaluation portion that, based on the image signal of the series of input images, evaluates the degree of reliability or ease of tracking by the tracking processing portion. The image playback device outputs the image signal of the series of output images to a display portion or to outside, Here, the region setting portion varies the extent of the evaluation value collection region in accordance with the evaluated degree.

For example, in any of the image shooting devices and image playback devices described above, the tracking evaluation portion may evaluate the degree based on the extent of the tracking target on the shot image or input image.

For example, in any of the image shooting devices and image playback devices described above, the tracking evaluation portion may evaluate the degree based on the position of the tracking target on the shot image or input image.

For example, in any of the image shooting devices and image playback devices described above, the tracking evaluation portion may evaluate the degree based on the movement of the tracking target on the series of shot images or series of input images.

For example, in any of the image shooting devices and image playback devices described above, the tracking evaluation portion may evaluate the degree based on the variation in an image characteristic of the tracking target on the series of shot images or series of input images.

For example, in any of the image shooting devices and image playback devices described above, the tracking evaluation portion may evaluate the degree by comparison of an image characteristic of the tracking target with an image characteristic around the tracking target on the shot image or input image.

For example, in any of the image shooting devices and image playback devices described above, the tracking evaluation portion may evaluate the degree based on luminance around the tracking target on the shot image or input image.

For example, in any of the image shooting devices and image playback devices described above, the tracking evaluation portion may evaluate the degree based on an estimation result of the color temperature of the light source with respect to the tracking target.

For example, in any of the image shooting devices and image playback devices described above, the tracking evaluation portion may evaluate the degree based on the magnitude of noise included in the shot image or input image.

The significance and benefits of the invention will be clear from the following description of its embodiments. It should however be understood that these embodiments are merely examples of how the invention is implemented, and that the meanings of the terms used to describe the invention and its features are not limited to the specific ones in which they are used in the description of the embodiments.

### BRIEF DESCRIPTION OF THE DRAWINGS

FIG. 1 is an overall block diagram of an image shooting device according to a first embodiment of the invention;

FIG. 2 is an internal configuration diagram of the image shooting portion in FIG. 1;

FIG. 3 is a perspective exterior view of the image shooting device of FIG. 1;

FIG. 4 is a block diagram, in connection with the first embodiment of the invention, of the blocks provided within the image shooting device which are particularly related to a subject tracking function;

FIG. 5 is a flow chart showing, in connection with the first embodiment of the invention, the flow of the operation of the image shooting device in a shooting mode;

FIG. 6 is a diagram showing, in connection with the first embodiment of the invention, an example of an initial setting frame image referred to in tracking processing;

FIG. 7 is a diagram showing, in connection with the first embodiment of the invention, how a calculation target image as a frame image is divided into a plurality of small blocks;

FIG. 8 is a diagram illustrating a method for evaluation of tracking reliability by the tracking reliability evaluation portion in FIG. 4, showing a calculation target image as a frame image having superimposed on it the center of a tracking target etc.;

FIGS. 9A to 9C are diagrams showing, in connection with the first embodiment of the invention, how the size of a clipping region is varied in accordance with tracking reliability;

FIG. 10 is a flow chart showing, in connection with the first embodiment of the invention, a procedure for setting a clipping region;

FIG. 11 shows, in connection with the first embodiment of the invention, an image on an XY coordinate plane;

FIG. 12A is a diagram showing, in connection with the first embodiment of the invention, a tracking target region within a frame image;

FIG. 12B is a diagram showing, in connection with the first embodiment of the invention, a clipping region within a frame image;

FIG. 13 is a diagram showing, in connection with the first embodiment of the invention, a preliminarily set clipping region projecting out of a frame image;

FIG. 14 is a diagram showing, in connection with the first embodiment of the invention, a series of chronologically ordered frame images and a series of clipped images cut out of them;

FIG. 15 is a block diagram, in connection with the second embodiment of the invention, of the blocks provided within the image shooting device which are particularly related to a subject tracking function;

FIG. 16 is a flow chart showing, in connection with the second embodiment of the invention, the flow of the operation of the image shooting device in a shooting mode;

FIG. 17 is a diagram showing, in connection with the second embodiment of the invention, a relationship between zoom lens position, angle of view, and optical zoom magnification;

FIGS. 18A to 18C are diagrams showing, in connection with the second embodiment of the invention, how angle of view (shooting angle of view) is varied in accordance with tracking reliability;

FIG. 19 is a block diagram of part of an image shooting device according to the third embodiment of the invention;

FIG. 20 is an internal block diagram, in connection with the third embodiment of the invention, of an AF evaluation value calculation portion provided in the image shooting device;

FIG. 21 is a diagram showing, in connection with the third embodiment of the invention, how a plurality of small blocks belong within an AF evaluation region set in a frame image;

FIG. 22 is a flow chart showing, in connection with the third embodiment of the invention, the flow of the operation of the image shooting device in a shooting mode;

FIG. 23 is a block diagram of part of an image shooting device according to a fourth embodiment of the invention;

FIG. 24 is a flow chart showing, in connection with the fourth embodiment of the invention, a procedure of processing executed during image playback operation;

FIG. 25 is a diagram showing, in connection with a fifth embodiment of the invention, two frame images and optical flows between the two images;

FIG. 26 is a diagram showing, in connection with a sixth embodiment of the invention, the image center and a tracking target center on a calculation target image;

FIG. 27 is a diagram, in connection with the sixth embodiment of the invention, a series of chronologically ordered frame images and motion vectors between those frame images;

FIG. 28 is a diagram showing, in connection with the sixth embodiment of the invention, a relationship between a luminance level around a tracking target and a reliability evaluation value;

FIG. 29 is a diagram showing, in connection with the sixth embodiment of the invention, a distribution of color temperatures evaluated with respect to individual tracking target frame images; and

FIGS. 30A and 30B are diagrams showing, in connection with a conventional technology, an example of a clipping region supposed to be set when the reliability or ease of tracking is comparatively high and an example of a clipping region supposed to be set when it is comparatively low.

### DETAILED DESCRIPTION OF PREFERRED EMBODIMENTS

Hereinafter, embodiments of the present invention will be described specifically with reference to the accompanying drawings. Among different drawings referred to in the course of description, the same parts are identified by the same reference signs, and in principle no overlapping description of the same parts will be repeated.

### First Embodiment

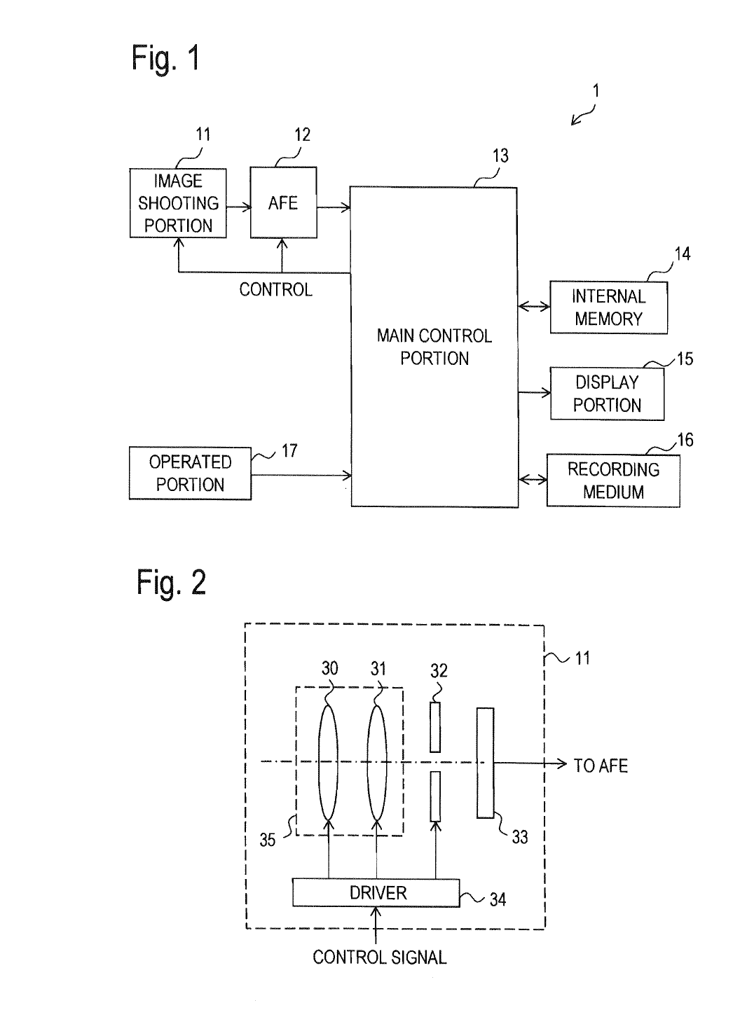

A first embodiment of the present invention will now be described. FIG. 1 is an overall block diagram of an image shooting device according to the first embodiment. The image shooting device 1 is a digital video camera capable of shooting and recording still images and moving images.

The image shooting device 1 is provided with an image shooting portion 11, an AFE (analog front-end) 12, a main control portion 13, an internal memory 14, a display portion 15, a recording medium 16, and an operated portion 17.

FIG. 2 is an internal construction diagram of the image shooting portion 11. The image shooting portion 11 includes an optical system 35, an aperture stop 32, an image sensing device (solid-state image sensing device) 33 such as a CCD (charge-coupled device) or CMOS (complementary metal oxide semiconductor) image sensor, and a driver 34 for driving and controlling the optical system 35 and the aperture stop 32. The optical system 35 is composed of a plurality of lenses including a zoom lens 30 and a focus lens 31. The zoom lens 30 and the focus lens 31 are movable along the optical axis. Based on a control signal from the main control portion 13, the driver 34 drives the zoom and focus lenses 30 and 31 and the aperture stop 32 to control the positions of the former and the aperture size of the latter, so as to thereby control the focal length (angle of view) and focus position of the image shooting portion 11 and the amount of light incident on the image sensing device 33.

An optical image representing a subject is incident through the optical system 35 and the aperture stop 32 on the image sensing device 33, which photoelectrically converts the optical image and outputs the resulting electrical signal to the AFE 12. More specifically, the image sensing device 33 is provided with a plurality of light-receiving pixels arrayed two-dimensionally in a matrix, and, during every period of shooting, each light-receiving pixel accumulates, as a signal charge, an amount of electric charge commensurate with the exposure time. The light-receiving pixels each output an analog signal of which the magnitude is proportional to the amount of electric charge accumulated as a signal charge there, and these analog signals are sequentially outputted to the AFE 12 in synchronism with drive pulses generated within the image shooting device 1. The length of the exposure time is controlled by the main control portion 13.

The AFE 12 amplifies the analog signals outputted from the image shooting portion 11 (image sensing device 33), and converts the amplified analog signals into digital signals. The AFE 12 outputs those digital signals sequentially to the main control portion 13. The amplification factor of the signal amplification in the AFE 12 is controlled by the main control portion 13.

The main control portion 13 is provided with a CPU (central processing unit), a ROM (read only memory), a RAM (random access memory), etc., and functions as a video signal processing portion. Based on the output signal of the AFE 12, the main control portion 13 generates a video signal representing the image shot by the image shooting portion 11. The main control portion 13 also functions as a display control portion for controlling what is displayed on the display portion 15, and controls the display portion 15 as desired to achieve display.

The internal memory 14 is formed of SDRAM (synchronous dynamic random access memory) or the like, and temporarily stores various kinds of data generated within the image shooting device 1. The display portion 15 is a display device such as a liquid crystal display panel, and displays a shot image, an image recorded on the recording medium 16, etc. under the control of the main control portion 13. The recording medium 16 is a non-volatile memory such as an SD (Secure Digital) memory card, and stores a shot image etc. under the control of the main control portion 13.

The operated portion 17 accepts operation from outside. Operation performed on the operated portion 17 are fed to the main control portion 13. The operated portion 17 is provided with, among others, a shutter release button (unillustrated) for requesting shooting and recording of a still image and a record button (unillustrated) for requesting shooting and recording of a moving image.

The image shooting device 1 operates in different operation modes including a shooting mode, in which it can shoot a still or moving image, and a playback mode, in which it can play back a still or moving image recorded on the recording medium 16 on the display portion 15. In the shooting mode, shooting is performed every predetermined frame period, so that the image sensing device 33 yields a series of shot images. The individual images composing this series of shot images are each called a “frame image.” A series of images (for example, a series of shot images) denotes a plurality of chronologically ordered images. A series of frame images can be displayed as a moving image on the display screen of the display portion 15.

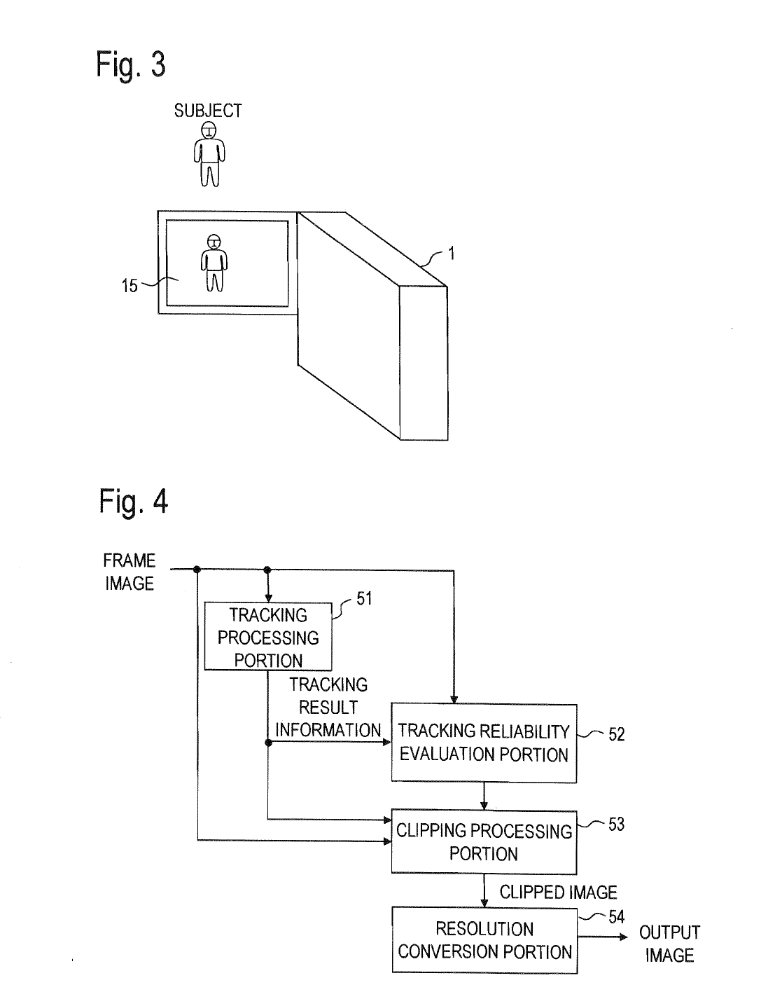

FIG. 3 is a perspective exterior view of the image shooting device 1 as seen from the shooter (the photographer). Also shown in FIG. 3 is a person as a subject. The shooter can, by observing how the subject appears on the display screen of the display portion 15, confirm the shooting range of the image shooting device 1.

The image shooting device 1 is furnished with an image-processing-based subject tracking function, and operates in a peculiar manner when the subject tracking function is in force. Operating the operated portion 17 in a predetermined manner enables the subject tracking function. Unless otherwise stated, the following description deals with how the image shooting device 1 operates when the subject tracking function is enabled (the same applies to the other embodiments described later as well). The data representing an image is called image data. The image data of a given frame image is generated from that part of the output signal of the AFE 12 which represents the optical image of that frame image. Image data can be read as an image signal. Moreover, a signal representing image data is occasionally called a video signal, and image data is equivalent to a video signal.

FIG. 4 is a block diagram of, among the blocks provided within the image shooting device 1, those which are particularly related to the subject tracking function. In FIG. 4, the blocks identified by the reference signs 51 to 54 are provided within the main control portion 13 in FIG. 1. The image data of the individual frame images composing a series of frame images is sequentially fed to a tracking processing portion 51, to a tracking reliability evaluation portion 52, and a clipping processing portion 53.

Based on the image data of a series of frame images, the tracking processing portion 51 detects the position of a particular subject within one after another of those frame images, and thereby tracks the position of the particular subject through the series of frame images. The particular subject to be tracked will be referred to as the “tracking target” in the following description. Here, it is assumed that the tracking target is a person.

The tracking processing portion 51 is also equipped to function as a face detection portion (unillustrated); based on the image data of a frame image, it detects a human face from the frame image, and extracts a face region including the detected face. This is achieved by processing called face detection processing. There have been known a variety of methods for detecting a face included in an image, and the tracking processing portion 51 can adopt any of them. For example, as by the method disclosed in JP-A-2000-105819, it is possible to detect a face (face region) by extracting a skin-colored region from a frame image. Or, it is possible to detect a face (face region) by the method disclosed in JP-A-2006-211139 or JP-A-2006-72770.

Based on the image data of a series of frame images, the tracking reliability evaluation portion 52 evaluates the reliability (the degree of reliability), or the ease (the degree of ease), of the tracking by the tracking processing portion 51. The reliability of tracking and the ease of tracking have similar, or analogous, significances. Strictly speaking, the reliability of tracking is construed to indicate how reliable the tracking executed in the past was, and the ease of tracking is construed to indicate how easy the tracking to be executed in the future will be. The higher the ease of tracking, the higher the reliability of tracking; the lower the ease of tracking, the lower the reliability of tracking. In the following description, for the sake of convenience of description, it is assumed that “the tracking processing portion 51 evaluates the reliability of tracking,” but the reliability of tracking can be read as the ease of tracking. Reliability of tracking and tracking reliability refers to the same thing.

Based on the result of the tracking processing by the tracking processing portion 51 and the result of the evaluation of the tracking reliability by the tracking reliability evaluation portion 52, the clipping processing portion 53 sets, within each frame image, a clipping region including a tracking target region where the image data corresponding to the tracking target is present, and cuts the image within the clipping region out of the frame image. The thus cut out image within the clipping region is called a “clipped image.” The clipping region is smaller than the entire region of the frame image, and the clipped image is a partial image of the frame image. Accordingly, the image size of the clipped image (the numbers of pixels in the horizontal and vertical directions) is smaller than that of the frame image. The image data of the clipped images generated by the clipping processing portion 53 is sequentially fed to a resolution conversion portion 54.

The resolution conversion portion 54 executes image processing for enhancing the resolution of the clipped images (hereinafter called resolution enhancement processing). For example, by interpolation processing such as linear interpolation, or by super-resolution processing, the resolution of the clipped images is enhanced. The clipped images having undergone resolution enhancement are called output images. The resolution conversion portion 54 generates and outputs the image data of the output images.

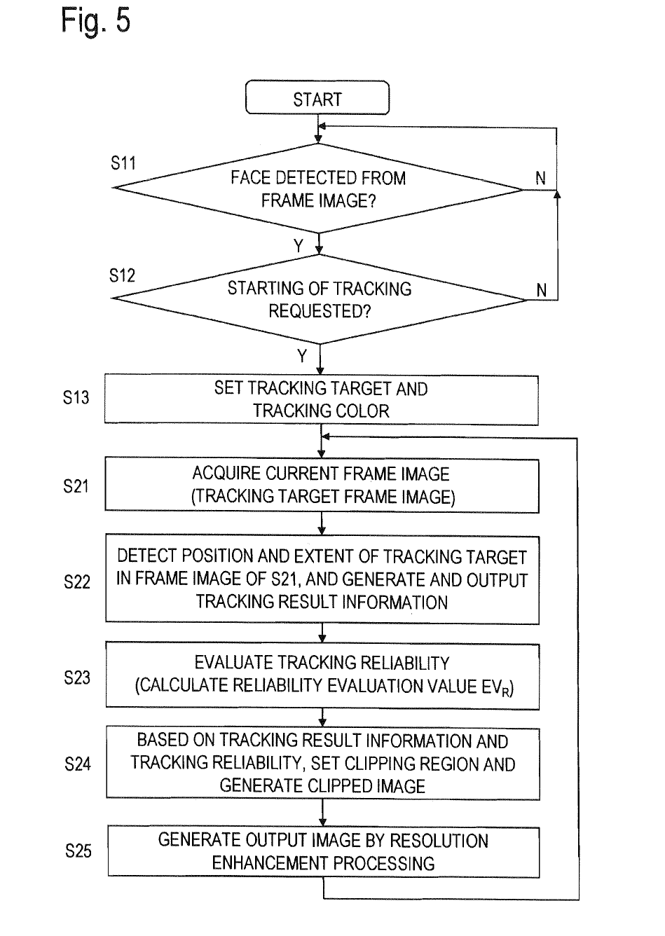

Operation during shooting: With reference to FIG. 5, how the image shooting device 1 operates when the subject tracking function is enabled will now be described in more detail. FIG. 5 is a flow chart showing the flow of the operation of the image shooting device 1 in the shooting mode. In the shooting mode, when the subject tracking function is enabled, the tracking processing portion 51 in FIG. 4 performs face detection processing on the frame images fed sequentially in. The frame images fed sequentially in are displayed on the display portion 15 on a constantly refreshed basis. The main control portion 13 checks whether or not a face has been detected from the current frame image (step S11), and also checks whether or not the operated portion 17 has been operated in a predetermined manner to start tracking (step S12); if a face has been detected and in addition the operated portion 17 has been operated in a predetermined manner to start tracking, an advance is made to step S13, and the processing in step S13 is executed.

In step S13, the tracking processing portion 51 takes as an initial setting frame image the frame image obtained immediately before the step S13 is reached from which a face was detected; based on the image data of the initial setting frame image, the tracking processing portion 51 then sets a tracking target and a tracking color.

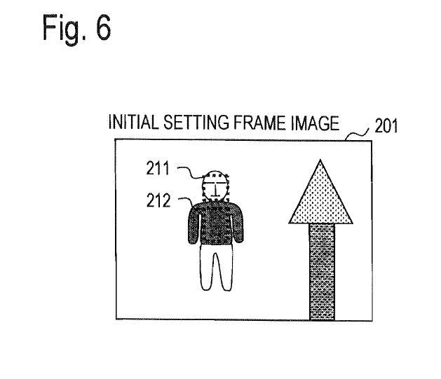

A method of setting a tracking target and a tracking color will now be described with reference to FIG. 6. FIG. 6 shows an image 201 as an example of the initial setting frame image. In FIG. 6, a broken-line rectangular region 211 is a face region extracted from the initial setting frame image 201 by face detection processing. The tracking processing portion 51 sets as a tracking target the person whose face is included in the face region 211. After extraction of the face region 211, the tracking processing portion 51 detects a body region 212 as a region including the body part of the person corresponding to the face region 211. The body region 212 is a rectangular region located under the face region 211 (in the direction pointing from the middle of the forehead to the mouth). The position and extent of the body region 212 in the initial setting frame image are determined depending on the position and extent of the face region 211.

Thereafter, based on the image data of the image within the body region 212, the tracking processing portion 51 identifies the color within the body region 212, and sets the identified color as a tracking color. For example, based on the color signals (for example, RGB signals) of the pixels forming the image within the body region 212, a color histogram of the image within the body region 212 is created. Then, based on the color histogram, the dominant color or most frequent color in the image within the body region 212 is found, and the thus found color is set as a tracking color. The dominant color of a given image is the color that occupies the largest part of the image region of that image, and the most frequent color of a given image is the color of the highest frequency in the color histogram of that image (the dominant color can be the same as the most frequent color). Alternatively, the color signals (for example, RGB signals) of the pixels forming the image within the body region 212 are averaged to find the average color of the image within the body region 212, and this average color may be set as a tracking color.

In step S13, a tracking target and a tracking color may be set by manual operation on the operated portion 17. For example, by operation on the operated portion 17, a user specifies the position, on a frame image, of a person to be taken as a tracking target and thereby sets a tracking target; by operation on the operated portion 17, a user specifies a tracking color and thereby sets a tracking color.

After a tracking target and a tracking color are set in step S13, the loop processing in steps S21 through S25 is executed repeatedly. Through this loop processing, the tracking processing portion 51 executes tracking processing on a series of frame images obtained after the tracking target and the tracking color are set. The individual frame images forming this series of frame images to which to apply tracking processing are referred to especially as tracking target frame images. Based on the image data of the tracking target frame images, the tracking processing portion 51 detects the position and extent of the tracking target in each of the tracking target frame images.

The tracking processing portion 51 performs tracking processing based on color information of the tracking target. Usable as methods for tracking processing based on color information are those disclosed in JP-A-H5-284411, JP-A-2000-48211, JP-A-2001-169169, etc. In the example under discussion, the color information of the tracking target is expressed by the tracking color set as described above. Thus, based on the color signals of a tracking target frame image, the tracking processing portion 51 extracts from the tracking target frame image a region of a color closely similar to the tracking color. The region thus extracted is regarded as a body region of the tracking target within the tracking target frame image.

Specifically, for example, within a tracking target frame image of interest, a tracking frame with an extent about that of the body region of the tracking target is set; while the tracking frame is moved from one position to another within the search range, at each position, similarity between the color of the image within the tracking frame and the tracking color is evaluated, and the position of the tracking frame where the closest similarity is obtained is judged to be where the body region of the tracking target is located. The search range for the current tracking target frame image is set relative to the position of the tracking target in the previous tracking target frame image. Usually, the search range is a rectangular region centered at the position of the tracking target in the previous tracking target frame image, and the size (image size) of the search range is smaller than the size of the entire region of a frame image.

The tracking processing portion 51 executes the above-described tracking processing based on color information on one tracking target frame image after anther fed to it, and thereby detects the position of the tracking target in each tracking target frame image. For example, the position of the tracking target is expressed by the center coordinates of the body region of the tracking target.

The extent of the tracking target as it appears on the tracking target frame images varies with, among others, variation in the distance between the tracking target and the image shooting device 1 in the real space. This requires that the extent of the above-mentioned tracking frame be altered appropriately in accordance with the extent of the tracking target as it appears on the tracking target frame images. This alteration is realized by a subject size detection method used in a known tracking algorithm. For example, in a tracking target frame image, it is assumed that the background appears at a point sufficiently apart from a point where the body of the tracking target is expected to be located, and, based on the image characteristics of those two points, the tracking processing portion 51 classifies the pixels located between the two points into either those belonging to the background or those belonging to the tracking target. Image characteristics include luminance information and color information. Through this classification, the contour of the tracking target is estimated. Then, from the contour, the extent of the tracking target is estimated, and in accordance with the thus estimated extent, the extent of the tracking frame is set.

Setting the extent of the tracking frame is equivalent to detecting the extent of the body region of the tracking target in a tracking target frame image. Moreover, since the extent of the tracking target is proportional to the extent of the body region, when the extent of the body region is detected, simultaneously the extent of the tracking target is identified. Thus, the tracking processing portion 51 detects the position and extent of the tracking target in each tracking target frame image. Tracking result information including information representing the detected position and extent (in other words, information representing the position and extent of the tracking target region) is fed to the tracking reliability evaluation portion 52 and to the clipping processing portion 53 (see FIG. 4).

Based on the result of detection of the position and extent of the tracking target, the tracking processing portion 51 can set an image region where the entire image of the tracking target appears. Of the entire region of a frame image, the image region where the entire image of the tracking target appears (the region where the image data representing the tracking target is present) is called a tracking target region, and the image region where no part of the tracking target appears (the region where no image data representing the tracking target is present) is called a background region. The tracking target region is set to include the entire image of the tracking target and in addition be as small as possible.

As a method for estimating the extent of the tracking target (the extent of the main subject) in the tracking target frame images, any other method than that described above may be adopted (for example, the methods disclosed in JP-A-2004-94680 and JP-A-H9-189934).

The processing executed in steps S21 through S25 will now be described. After the tracking target and the tracking color are set in step S13, first, the processing in step S21 is executed.

In step S21, the current frame image is acquired from the part of the output signal of the AFE 12 which corresponds to one frame image at the moment. The frame image acquired here is, as described above, a tracking target frame image. Subsequently, in step S22, the tracking processing portion 51, through the tracking processing described above, detects the position and extent of the tracking target in the current frame image obtained in step S21, then creates tracking result information including information representing the detected position and extent, and then outputs the tracking result information to the tracking reliability evaluation portion 52 and to the clipping processing portion 53.

Subsequently to Step S22, in step S23, the tracking reliability evaluation portion 52 evaluates the tracking reliability at the moment; in other words, it evaluates the reliability of the position (and extent) of the tracking target as detected with respect to the frame image obtained in step S21.

The evaluation here is carried out, for example, by the following method. The evaluated reliability is represented by an evaluation value called a reliability evaluation value and represented by EV_{R}. For each tracking target frame image, a reliability evaluation value can be calculated. EV_{R} takes a value of 0 or more but 100 or less, and the higher the tracking reliability is evaluated, the greater the reliability evaluation value EV_{R} is.

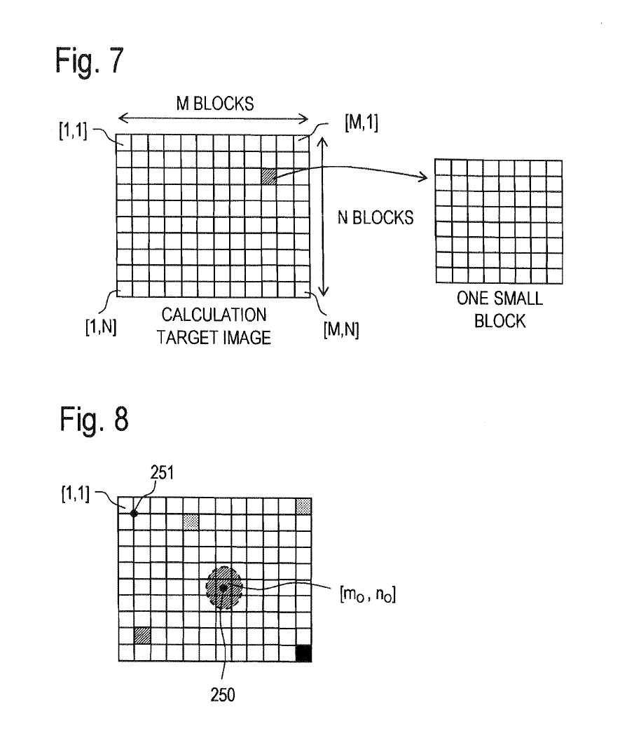

The tracking reliability evaluation portion 52 handles the tracking target frame image acquired in step S21 as a calculation target image. It then, as shown in FIG. 7, divides the entire region of the calculation target image into a plurality of parts in the horizontal and vertical directions, and thereby sets a plurality of small blocks within the calculation target image. Suppose now that the number of division in the horizontal and vertical directions are M and N respectively (where M and N are each an integer of 2 or more). Each small block is composed of a plurality of pixels arrayed two-dimensionally. Moreover, let us introduce m and n (where m is an integer fulfilling 1=m=M and n is an integer fulfilling 1=n=N) as the symbols representing the horizontal and vertical positions of a given small block within the calculation target image. Here, it is assumed that the greater the value of m, the more rightward the horizontal position is, and that the greater the value of n, the more downward the vertical position is. The small block whose horizontal and vertical positions are m and n respectively is represented by the small block [m, n].

Based on the tracking result information, the tracking reliability evaluation portion 52 recognizes the center of the body region of the tracking target in the calculation target image, and identifies the small block to which the position of that center belongs. In FIG. 8, the center is represented by a point 250. Suppose here that the center 250 belongs to the small block [m_{O}, n_{O}] (where m_{O} is an integer fulfilling 1=m_{O}=M and no is an integer fulfilling 1=n_{O}=N). Moreover, by the subject size detection method mentioned above, the small blocks are classified into either those where the image data of the tracking target appears or those where the image data of the background appears. The former small blocks are called subject blocks and the latter small blocks are called background blocks. FIG. 8 conceptually shows a case where the color of the tracking target appearing around the center 250 differs from the color of the background.

The region composed of all the subject blocks put together can be thought of as the tracking target region, and the region composed of all the background blocks put together can be thought of as the background region.

For each background block, the tracking reliability evaluation portion 52 calculates a color difference evaluation value representing the difference between the color of the image within the background block and the set tracking color. Suppose that there are Q of the background blocks, and the color difference evaluation values calculated for the first to Qth background blocks are represented by C_{DIS}[1] to C_{DIS}[Q] respectively (where Q is an integer fulfilling the inequality “2=Q=(M×N)−1”). For example, to calculate the color difference evaluation value C_{DIS}[1], the color signals (for example, RGB signals) of the pixels belonging to the first background block are averaged, thereby the average color of the image within the first background block is found, and then the position of the average color in the RGB color space is detected. On the other hand, the position, in the RGB color space, of the tracking color set for the tracking target is also detected, and the distance between the two positions in the RGB color space is calculated as the color difference evaluation value C_{DIS}[1]. Thus, the greater the difference between the colors compared, the greater the color difference evaluation value C_{DIS}[1]. Here, it is assumed that the RGB color space is normalized such that the color difference evaluation value C_{DIS}[1] takes a value in the range of 0 or more but 1 or less. The other color difference evaluation values C_{DIS}[2] to C_{DIS}[Q] are calculated likewise. The color space for calculating the color difference evaluation values may be other than the RGB color space (for example, the HSV color space). Needless to say, with respect to a given image region of interest, the position of the color within the image region as located in a color space is one kind of quantity representing a characteristic of the image within that image region (image characteristic quantity).

Furthermore, for each background block, the tracking reliability evaluation portion 52 calculates a position difference evaluation value representing the spatial difference between the positions of the center 250 and of the background block on the calculation target image. The position difference evaluation values calculated for the first to Qth background blocks are represented by P_{DIS}[1] to P_{DIS}[Q] respectively. With respect to a given background block, the position difference evaluation value is given as the distance between the center 250 and, of the four vertices of that background block, the one closest to the center 250. Suppose that the small block [1, 1] is the first background block, with 1<m_{O} and 1<n_{O}, and that, as shown in FIG. 8, of the four vertices of the small block [1, 1], the vertex 251 is closest to the center 250, then the position difference evaluation value P_{DIS}[1] is given as the spatial distance between the center 250 and the vertex 251 on the calculation target image. Here, it is assumed that the space region of the calculation target image is normalized such that the position difference evaluation value P_{DIS}[1] takes a value in the range of 0 or more but 1 or less. The other position difference evaluation values P_{DIS}[2] to P_{DIS}[Q] are calculated likewise.

Based on the color difference evaluation values and the position difference evaluation values found as described above, the tracking reliability evaluation portion 52 calculates an integrated distance CP_{DIS} for the calculation target image of interest according to formula (1) below. It then calculates, by using the integrated distance CP_{DIS}, a reliability evaluation value EV_{R} for the calculation target image of interest. Specifically, when “CP_{DIS}>100,” then “EV_{R}=0”; when “CP_{DIS}≦100,” then “EV_{R}=100—CP_{DIS}.” As will be understood from this calculation method, when a background of the same color as, or a similar color to, the tracking color is present near the tracking target, the reliability evaluation value EV_{R} is low.

$$\begin{matrix}{CP}_{DIS} = {\sum }_{i = 1}^{Q} \sqrt{( 1 - {C}_{DIS} ( i ) ) \times ( 1 - {P}_{DIS} ( i ) )} & ( 1 ) \\ {EV}_{R} = \{ \begin{matrix}0 \text{:} & if {CP}_{DIS} > 100 \\ 100 - {CP}_{DIS} \text{:} & if {CP}_{DIS} \leq 100\end{matrix} & ( 2 )\end{matrix}$$

After the tracking reliability is evaluated in step S23 in FIG. 5, the processing in step S24 is executed. In step S24, based on the latest tracking result information outputted from the tracking processing portion 51 and the latest tracking reliability evaluated by the tracking reliability evaluation portion 52, the clipping processing portion 53 sets a clopping region within the entire region of the frame image obtained in step S21, and cuts out, from the frame image, the image within the clipping region as a clipped image.

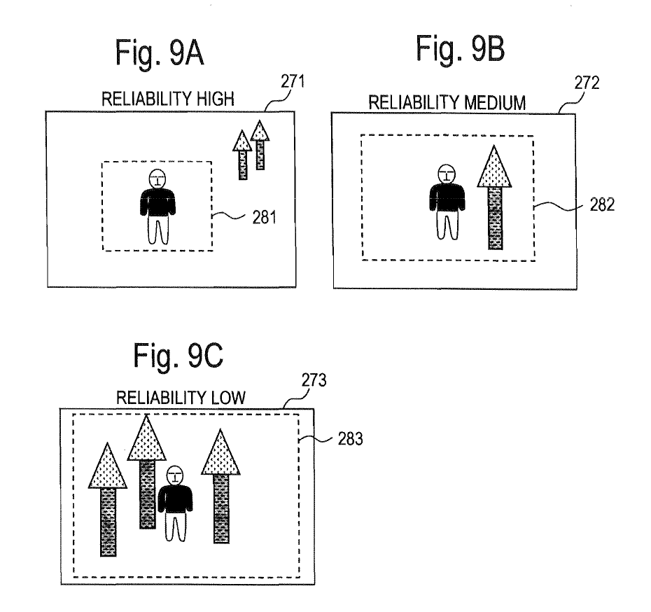

Here, assuming that the extent of the tracking target remains constant on the frame images, the clipping region is set such that, as the tracking reliability becomes higher, the clipping region becomes smaller as shown in FIGS. 9A to 9C. FIGS. 9A, 9B, and 9C show how the clipping region is set when the tracking reliability is at a first, a second, and a third degree of reliability respectively. It is assumed that, of the first, second, and third degrees of reliability, the first is the highest and the third is the lowest. In FIGS. 9A to 9C, the images 271 to 273 within the solid-line rectangular frames are each a frame image within which to set a clipping region, and the regions 281 to 283 within the broken-line rectangular frames are each a clipping region. The person within each clipping region is the tracking target. Due to a color similar to the tracking color of the tracking target being located near the tracking target, the tracking reliability with respect to the frame images 272 and 273 is lower than that with respect to the frame image 271.

The size of the clipping region 281 set with respect to the frame image 271 is smaller than the size of the clipping region 282 set with respect to the frame image 272, and in addition the size of the clipping region 282 is smaller than the size of the clipping region 283 set with respect to the frame image 273. The size of a clipping region is the image size of the clipping region which represents the extent of the clipping region, and is expressed by the number of pixels belonging within the clipping region.

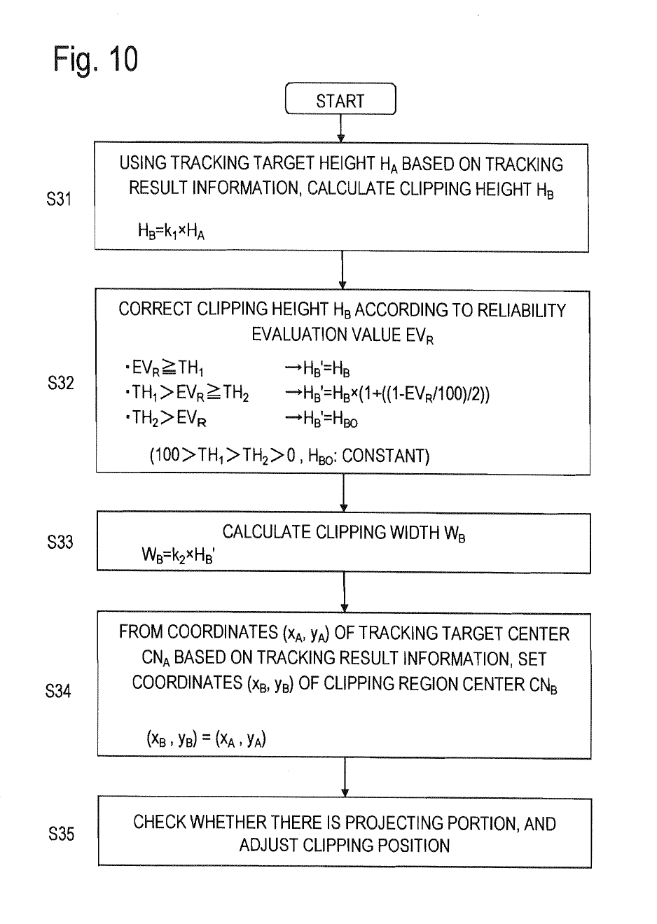

Now, with reference to FIG. 10, an example of a method for setting a clipping region in step S24 will be described in more detail. FIG. 10 is a flow chart showing the procedure for setting a clipping region, and the clipping processing portion 53 executes the processing in steps S31 through S35 sequentially.

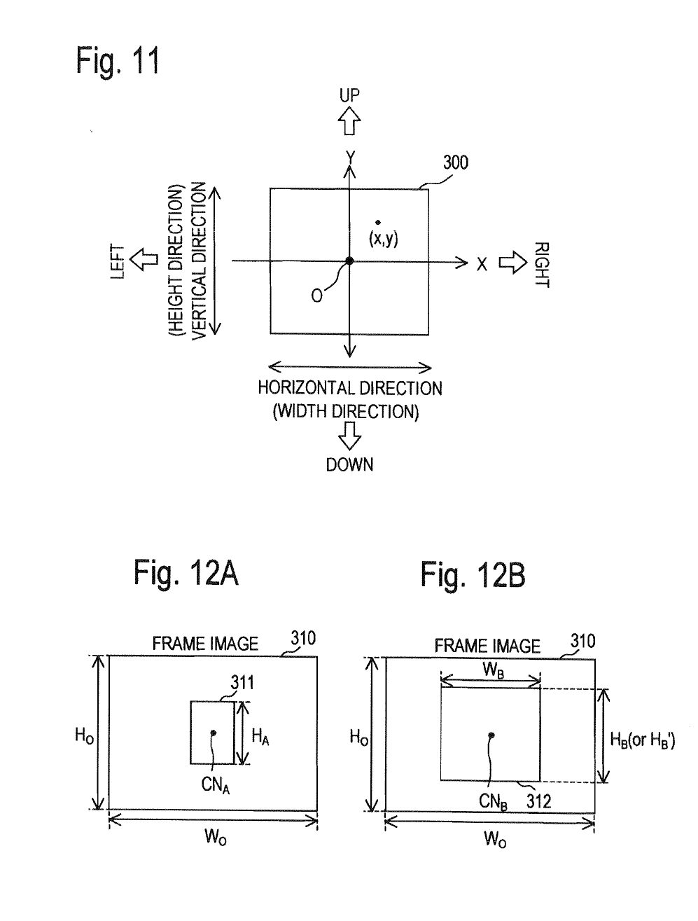

Prior to the description of the processing shown in FIG. 10, with reference to FIG. 11, the significance of coordinates on an image etc. will be explained. FIG. 11 shows an arbitrary image 300, such as a frame image, on an XY coordinate plane. It is assumed that the XY coordinate plane is a two-dimensional coordinate plane having mutually perpendicular axes, namely X and Y axes, as coordinate axes, the X axis extending in a direction parallel to the horizontal direction of the image 300, the Y axis extending in a direction parallel to the vertical direction of the image 300. When an object or region on an image is discussed, the dimension (size) of the object or region in the X-axis direction is taken as its width, and the dimension (size) of the object or region in the Y-axis direction is taken as its height. The coordinates of a given point of interest on the image 300 are represented by (x, y). The symbols x and y represent the coordinates of the given point of interest in the horizontal and vertical directions, respectively. The X and Y axes intersect at an origin O and, relative to the origin O, the positive direction of the X axis points rightward, the negative direction of the X axis points leftward, the positive direction of the Y axis points upward, and the negative direction of the Y axis points downward.

The processing in steps S31 through S35 will now be described step by step. First, in step S31, by using the height H_{A} of the tracking target included in the tracking result information, the clipping processing portion 53 calculates a clipping height H_{B} according to the formula “H_{B}=k₁×H_{A}.” The symbol k₁ represents a previously set constant greater than 1. FIG. 12A shows a frame image 310 with respect to which to set a clipping region, along with a rectangular region 311 representing a tracking target region in which the image data of the tracking target is present in the frame image 310. FIG. 12B shows the same frame image 310 as the one shown in FIG. 12A, along with a rectangular region 312 representing a clipping region to be set with respect to the frame image 310. Although the tracking target region is shown as a rectangular region in FIG. 12A, the exterior shape of a tracking target region is not necessarily be rectangular.

The height-direction dimension (size) of the tracking target region as the rectangular region 311 is the height H_{A} of the tracking target, and the height-direction dimension (size) of the clipping region as the rectangular region 312 is the clipping height H_{B}. The height- and width-direction dimensions (size) of the entire region of the frame image 310 are represented by H_{O} and W_{O} respectively.

The clipping height calculated in step S31 is, in step S32, corrected in accordance with the reliability evaluation value EV_{R}, which represents the tracking reliability. The corrected clipping height is represented by H_{B}′ (though no substantive correction may be made, in which case H_{B}′=H_{B}). Specifically, the latest reliability evaluation value EV_{R} is compared with predetermined threshold values TH₁ and TH₂ to check which of the three, first to third, inequalities given below holds. The threshold values TH₁ and TH₂ are previously set such that they fulfill the inequality “100>TH₁>TH₂>0”; for example, TH₁=95 and TH₂=75.

If a first inequality “EV_{R}≧TH₁” holds, H_{B} is substituted in height H_{B}′. That is, when the first inequality holds, no correction is made in the clipping height calculated in step S31.

If a second inequality “TH₁>EV_{R}≧TH₂” holds, a corrected clipping height H_{B}′ is calculated according to the formula “H_{B}′=H_{B}×(1+((1−EV_{R}/100)/2)).” That is, when the second inequality holds, the clipping height is corrected upward.

If a third inequality “TH₂>EV_{R}” holds, H_{BO} is substituted in H_{B}′. H_{BO} represents a constant based on the height H_{O} of the frame image 310, the constant being, for example, equal to the height H_{O}, or slightly smaller than the height H_{O}. Also when the third inequality holds, the clipping height is corrected upward.

Subsequently to step S32, in step S33, by use of the corrected clipping height H_{B}′, a clipping width W_{B} is calculated according to the formula “W_{B}=k₂×H_{B}′.” The clipping width W_{B} is the width-direction dimension (size) of the clipping region as the rectangular region 312. The symbol k₂ represent a previously set constant (for example, k₂=16/9). Unless the width-direction dimension of the tracking target region is abnormally great in comparison with its height-direction dimension, the tracking target region is included in the clipping region. The example under discussion assumes a case in which the tracking target is a person and the direction of the height of the person coincides with the vertical direction of the image, and thus it is assumed that no tracking target region is set of which the width-direction dimension is abnormally great in comparison with its height-direction dimension.

Thereafter, in step S34, the clipping processing portion 53 acquires from the tracking result information the coordinates (x_{A}, y_{A}) of the center CN_{A} of the tracking target, and sets the coordinates (x_{B}, y_{B}) of the center CN_{B} of the clipping region such that (x_{B}, y_{B})=(x_{A}, y_{A}).

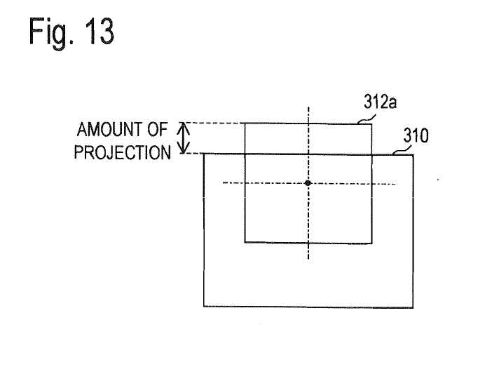

The clipping region set at this stage may include a region falling outside the entire region of the frame image 310. For example, as shown in FIG. 13, part of a clipping region 312a may be located outside, on the top side of, the entire region of the frame image 310. A part of a clipping region that falls outside the entire region of the frame image 310 is called a projecting region. The size of a projecting region in the direction in which it projects is called the amount of projection.

In step S35, whether or not there is a projecting portion is checked. If there is no projecting portion, the clipping region based on the clipping height H_{B}′, the clipping width W_{B}, and the coordinates (x_{B}, y_{B}) set through the processing in steps S31 through S34 is taken as the definitive clipping region to be set in step S24 in FIG. 5.

If there is a projecting portion, clipping position adjustment is performed on the clipping region based on the clipping height H_{B}′, the clipping width W_{B}, and the coordinates (x_{B}, y_{B}) set through the processing in steps S31 through S34, and the clipping region after the clipping position adjustment is taken as the definitive clipping region to be set in step S24 in FIG. 5.

In the clipping position adjustment, the coordinates of the center CN_{B} of the clipping region are corrected such that the amount of projection becomes exactly zero. For example, in a case where, as shown in FIG. 13, the clipping region 312a projects on the top side of the frame image 310, the center CN_{B} of the clipping region is shifted downward by the amount of projection. Specifically, when the amount of projection is represented by Δy, a corrected y-axis coordinate y_{B}′ is calculated according to “y_{B}′=y_{B}−Δy,” so that (x_{B}, y_{B}′) is taken as the coordinates of the center CN_{B} of the definitive clipping region to be set in step S24 in FIG. 5.

Likewise, in a case where the clipping region projects on the bottom side of the frame image, the center CN_{B} of the clipping region is shifted upward by the amount of projection; in a case where the clipping region projects on the right side of the frame image, the center CN_{B} of the clipping region is shifted leftward by the amount of projection; in a case where the clipping region projects on the left side of the frame image, the center CN_{B} of the clipping region is shifted rightward by the amount of projection; then the thus shifted clipping region is set as the definitive clipping region.

If, as a result of the clipping region being shifted downward, it comes to project on the bottom side of the frame image, the size of the clipping region (the clipping height and width) is corrected downward such as to eliminate the projection. Such downward correction tends to become necessary when the clipping height H_{B}′ is comparatively great.

Back in FIG. 5, after the clipping region is set and a clipped image is generated from the frame image obtained in step S21 as described above, the processing in step S25 is executed. In step S25, the resolution conversion portion 54 executes resolution enhancement processing to enhance the resolution of the clipped image, and thereby generates an output image (i.e., the clipped image after resolution enhancement).

Resolution enhancement processing is realized by, for example, interpolation processing using the image data of one frame image. In this case, for example in a case where the image size of the frame image out of which to cut a clipped image is 1920×1080 and the image size of the clipped image before resolution enhancement is 960×540, the image size of the clipped image before resolution enhancement is augmented by a factor of 2 in each of the horizontal and vertical directions to generate a clipped image (i.e., the clipped image after resolution enhancement) having an image size of 1920×1080. Augmentation of image size is realized by resolution conversion using interpolation processing. Various methods are usable as method for interpolation processing, examples including a nearest neighbor method, a bilinear method, and a bicubic method.

The clipped image after resolution enhancement as obtained through the above-described interpolation processing (hereinafter referred to as a pre-sharpening image) may be further subjected to sharpening processing, so that the image after the sharpening processing (hereinafter referred to as a post-sharpening image) may be taken as the output image of the resolution conversion portion 54. For example, by subjecting a pre-sharpening image to filtering using an edge enhancement filter (such as a differentiation filter) or an unsharp mask filter, it is possible to generate a post-sharpening image. Filtering using an unsharp mask filter is also called unsharp masking. In unsharp masking, first a pre-sharpening image is smoothed to generate a smoothed image, and then a differential image between the smoothed image and the pre-sharpening image is generated; then the differential image and the pre-sharpening image are blended such that the individual pixel values of the former and the individual pixel values of the latter are added up, and thereby a post-sharpening image is generated.

Alternatively, resolution enhancement processing may be realized by super-resolution processing using a plurality of frame images. In super-resolution processing, a plurality of mutually displaced low-resolution images are referred to, and, based on the amount of displacements among those low-resolution images and the image data of those low-resolution images, the resolution of the low-resolution images is augmented to generate a single high-resolution image. The resolution conversion portion 54 can use any known super-resolution processing; it can use, for example, the super-resolution processing methods disclosed in JP-A-2005-197910, JP-A-2007-205, and JP-A-2007-193508.

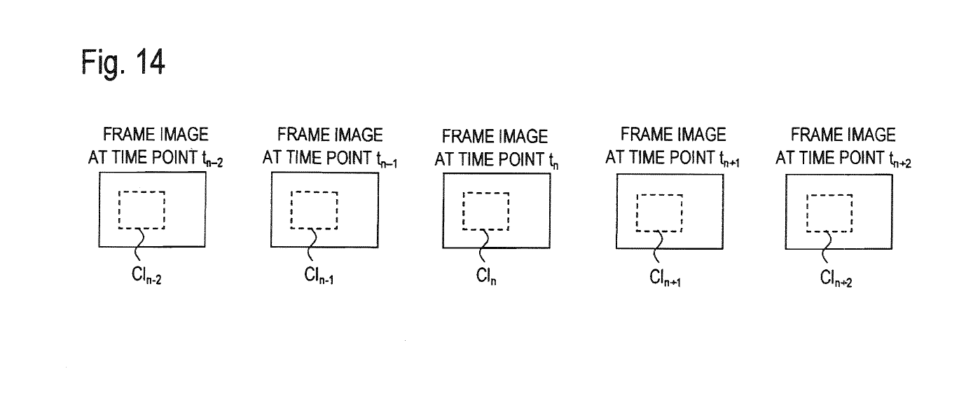

For example, in a case where super-resolution processing is performed by use of clipped images corresponding to three frames, the processing proceeds as follows. Suppose now that, every time the period of one frame passes, time points tₙ₋₂, tₙ₋₁, tₙ, tₙ₊₁, tₙ₊₂, . . . occur in this order. As shown in FIG. 14, the frame image acquired at time point tₙ₋ᵢ is called the frame image at time point tₙ₊ᵢ (where i is an integer). The clipped image cut out of the frame image at time point tₙ₊ᵢ is represented by CIₙ₊ᵢ. In the case under discussion, by use of three clipped images CIₙ₊ᵢ, CIₙ₊ᵢ₊₁, and CIₙ₊ᵢ₊₂, a single high-resolution image is generated.

As a specific example, consider a case where i is (−2). At the time point that the clipped image CIₙ is obtained, three clipped images CIₙ₋₂, CIₙ₋₁, and CIₙ are referred to, and, with the clipped images CIₙ₋₂, CIₙ₋₁, and CIₙ handled as a first, a second, and a third observed low-resolution image respectively, super-resolution processing is performed. With the first observed low-resolution image taken as the reference, the amount of displacement between the first and second observed low-resolution images and the amount of displacement between the first and third observed low-resolution images are detected. An amount of displacement is a two-dimensional quantity containing a horizontal and a vertical component, and is also called an amount of motion, or a motion vector. An amount of displacement is detected to have a sub-pixel resolution by a method such as a representative point matching method, a block matching method, or a gradient method. That is, the minimum detectable unit with which an amount of displacement is detected is smaller than the distance between adjacent pixels within a observed low-resolution image.

On the other hand, by linear interpolation or bicubic interpolation, an image obtained by augmenting the horizontal- and vertical-direction numbers of pixels of the first observed low-resolution image is generated as an initial high-resolution image. Thereafter, by use of the above-mentioned amounts of displacement, three low-resolution images that compose the high-resolution image at the moment is estimated, and the high-resolution image is updated in such a way as to minimize the errors between the estimated low-resolution images and the observed low-resolution images. The ultimately obtained high-resolution image corresponds to the clipped image CIₙ₋₂ after resolution enhancement. The resolution of the other clipped images is augmented likewise. For example, the augmentation of resolution with respect to the clipped image CIₙ₋₁ is achieved by use of the clipped images CIₙ₋₁, CIₙ, and CIₙ₊₁.

After the processing in step S25 in FIG. 5, a return is made to step S21, and then the loop processing in steps S21 through S25 is executed repeatedly.

A series of chronologically ordered output images of the resolution conversion portion 54 obtained through repetition of the above-described loop processing is displayed as a moving image on the display portion 15, and in addition the image data of the series of output images is recorded to the recording medium 16. Alternatively, a series of frame images inputted to the clipping processing portion 53, or a series of clipped images outputted from the clipping processing portion 53, may be displayed as a moving image on the display portion 15, and the image data of the series of frame images and the series of clipped images may be recorded to the recording medium 16.

By reading out the image data on the recording medium 16 with an arbitrary image playback device, it is possible to play back and display on it a moving image of clipped images in a composition good for the tracking target. In particular, by reading out the image data of clipped images after resolution enhancement, it is possible to play back and display a moving image of high-resolution clipped images.

When a moving image of a subject of interest is shot, conventionally, it is necessary to operate an image shooting device to adjust the shooting direction and zoom magnification in accordance with the movement of the subject while observing the subject on the display screen of the image shooting device so as not to loose sight of the subject. Thus, the operator (photographer) needs to concentrate on shooting, and this makes it difficult to shoot while communicating with the subject of interest or paying attention to any other thing. By contrast, according to this embodiment, simply by shooting with a comparatively wide angle of view such that a subject of interest (i.e., a tracking target) is located within the shooting region, it is possible, by clipping processing employing tracking processing, to sequentially generate clipped images including the subject of interest. Thus, simply by keeping the image shooting device pointing at the subject, the shooter can effortlessly acquire an image of the subject as he desires. Moreover, in time of playback, he can view an image in which the subject of interest is clipped out in an appropriate composition.

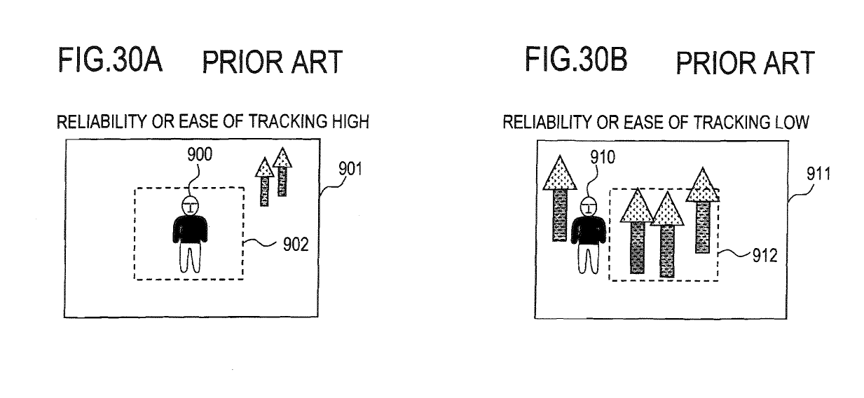

In this clipping processing, as described above, when the tracking reliability is comparatively high, the size of the clipping region is made comparatively small; when the tracking reliability is comparatively low, the size of the clipping region is made comparatively large. This, on one hand, makes it possible to acquire a moving image with a composition good for a subject of interest and, on the other hand, makes it possible to prevent, when the tracking reliability is comparatively low, a situation in which the subject of interest is not included in the clipping region (See FIG. 30B).

The above description assumes a case where the shooting region of the image shooting device 1 includes only one person. In a case where the shooting region includes a plurality of persons, preferably, one of them is selected as a tracking target. For example, from an initial setting frame image, the face region of each person is extracted; the initial setting frame image is then, with all the face regions indicated in it, displayed on the display screen of the display portion 15, and the user is allowed to select one person that he wants to select as a tracking target. This selection is made by operating on the operated portion 17. Alternatively, the display portion 15 may be made to function as a so-called touch panel so that, by operation on the touch panel, the selection is made. Alternatively, an image of the face of a person to be selected as a tracking target may be previously registered in the image shooting device 1. In this case, the image shooting device 1 automatically checks whether or not the registered face is included in the initial setting frame image and, if the registered face is found to be included in the initial setting frame image, the person with the registered face is selected as a tracking target.

Moreover, in a case where the shooting region includes a plurality of persons, each person may be taken as a tracking target so that a plurality of tracking target regions each including a tracking target may be set. For example, in a case where the shooting region includes two persons, each person is taken as a tracking target, and a tracking target region in which an image of one of them appears and a tracking target region in which an image of the other appears are separately set. Then, with respect to each tracking target region, a clipping region is set, and thus two clipped images are extracted from one frame image. The image data of the two clipped images before or after resolution enhancement may then be recorded separately to the recording medium 16. In time of image playback, for example, the user is allowed to select one of the two persons so that, with respect to the selected person, a moving image of clipped images is played back and displayed.

Operation during image playback: The operation in a case where tracking processing, clipping processing, and resolution enhancement processing are executed in time of shooting has been described above. Such processing may instead be executed in time of image playback. How the image shooting device 1 operates in time of image playback in that case will now be described. Here, it is assumed that, prior to such image playback operation, the image data of an entire series of chronologically ordered frame images obtained during shooting of a moving image is recorded on the recording medium 16.

During image playback, an image acquisition portion (unillustrated) provided in the stage preceding the tracking processing portion 51, the tracking reliability evaluation portion 52, and the clipping processing portion 53 in FIG. 4 is made to read out the frame images from the recording medium 16 sequentially in chronological order, and their image data is fed, in chronological order, to the tracking processing portion 51, to the tracking reliability evaluation portion 52, and to the clipping processing portion 53 so that the above-described processing in steps S11 through S13 and S21 through S25 in FIG. 5 is executed.

Then, preferably, a series of chronologically ordered output images of the resolution conversion portion 54 obtained through repetition of the loop processing in steps S21 through S25 is displayed as a moving image on the display portion 15. Alternatively, a series of clipped images outputted from the clipping processing portion 53 may be displayed as a moving image on the display portion 15. When image playback operation is performed, the image shooting device 1 functions as an image playback device.

By performing image playback operation as described above, it is possible, on one hand, to play back a moving image in a composition good for a subject of interest and, on the other hand, to prevent, when the tracking reliability is comparatively low, a situation in which the subject of interest is not included in the image played back

In the example described above, an image is played back and displayed on the display portion 15 provided in the image shooting device 1. Instead, the image data of an image to be displayed may be fed to a display device (unillustrated) external to the image shooting device 1 to display on that external display device a clipped image before or after resolution enhancement. It is also possible to feed, as necessary, the image data of a clipped image before or after resolution enhancement over a network or the like to an external device (such as a server device administering a web site) that uses the image data.

A method for executing tracking processing, clipping processing, and resolution enhancement processing in time of shooting and a method for executing tracking processing, clipping processing, and resolution enhancement processing in time of image playback have been described above. It is also possible to divide the whole processing into two parts of partial processing, with one part of partial processing executed in time of shooting and the other part of partial processing executed in time of image playback.

Specifically, one effective way of dividing the processing is as follows. First, in time of shooting, the processing in steps S11 through S13 and S21 through S23 in FIG. 5 is executed, and in addition the processing in step S24 is executed by the clipping processing portion 53 in FIG. 4, so that a clipping region is set within the entire region of the frame image obtained in step S21. Here, however, no actual clipping processing is performed, but clipping information indicating the size (extent) and position of the set clipping region is outputted to the clipping processing portion 53, and the clipping information is, in association with the image data of the series of frame images, recorded to the recording medium 16. In a case where recording is performed in this way, the resolution conversion portion 54 in FIG. 4 may be omitted. The position of the clipping region is determined by the coordinates, which are to be set in step S24 in FIG. 5, of the center CN_{B} of the clipping region (see also FIG. 10).

Association between clipping information and image data may be achieved by any method. For example, preferably, while the image data of frame images is stored in the main region of an image file recorded to the recording medium 16, the clipping information corresponding to the image data is stored in the header region of the same image file. In a case where the Exif (Exchangeable image file format) file format is complied with, a header region is called an Exif tag, or an Exif region. The file format of image files may conform to any standard.

In time of image playback, an image playback device (for example, the image shooting device 1) reads out, sequentially in chronological order, frame images along with clipping information from the recording medium 16, generates from the series of frame images a series of clipped images according to the clipping information, and plays back and displays the generated series of clipped images as a moving image. In a case where this image playback device is provided with the resolution conversion portion 54 in FIG. 4, the series of clipped images generated according to the clipping information may be subjected to the resolution enhancement processing described above so that the resolution conversion portion 54 generates a series of output images (the clipped images after resolution enhancement) and this series of output images is played back and displayed as a moving image.

In time of shooting in particular, fast, low-power-consumption processing is sought. By performing the processing for actually clipping images and the processing for resolution enhancement in time of image playback as described above, it is possible to reduce the load of processing in time of shooting and thereby achieve fast, low-power-consumption processing in time of shooting.

### Second Embodiment

A second embodiment of the present invention will now be described. The overall block diagram in FIG. 1 applies equally to an image shooting device according to the second embodiment. To distinguish the image shooting device according to the second embodiment from that according to the first embodiment, however, the image shooting device according to the second embodiment will be referred to by the reference sign 1a. The internal configuration shown in FIG. 2 applies equally to the image shooting portion 11 in the image shooting device 1a, and the perspective exterior view in FIG. 3 applies equally to the image shooting device 1a. Unless inconsistent, the image shooting device 1a can realize all the functions realized by the image shooting device 1 according to the first embodiment, and, unless inconsistent, all the description given in connection with the first embodiment equally applies to the second embodiment.

Like the image shooting device 1, the image shooting device 1a is furnished with an image-processing-based subject tracking function. A difference is that, whereas in the image shooting device 1 the size of the clipping region is varied with a view to generating an image with a good composition in accordance with the tracking reliability (in other words, the zoom magnification for electronic zooming is varied), in the image shooting device 1a the angle of view of the image shooting portion 11 is varied instead (in other words, the zoom magnification for optical zooming is varied).

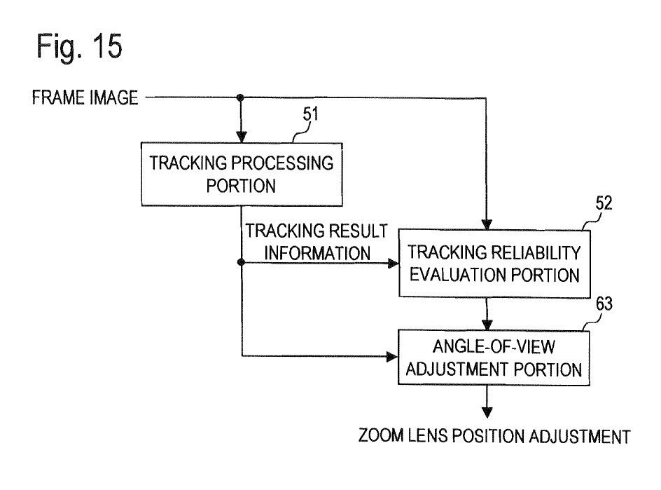

FIG. 15 is a block diagram of, among the blocks provided within the image shooting device 1a, those which are particularly related to the subject tracking function. In FIG. 15, the blocks identified by the reference signs 51, 52, and 63 are provided within the main control portion 13 in FIG. 1. The image data of the individual frame images composing a series of frame images is sequentially fed to a tracking processing portion 51 and to a tracking reliability evaluation portion 52. The tracking processing portion 51 and the tracking reliability evaluation portion 52 provided in the image shooting device 1a are the same as those in first embodiment.

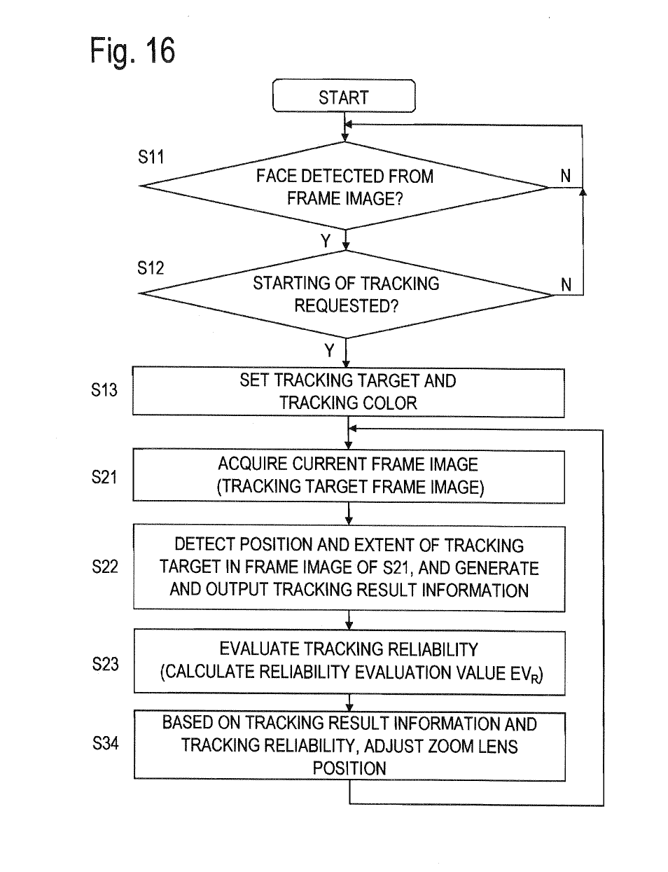

With reference to FIG. 16, how the image shooting device 1a operates when the subject tracking function is enabled will now be described in more detail. FIG. 16 is a flow chart showing the flow of the operation of the image shooting device 1a in the shooting mode. In the shooting mode, when the subject tracking function is enabled, the tracking processing portion 51 performs face detection processing on the frame images fed sequentially in. The main control portion 13 checks whether or not a face has been detected from the current frame image (step S11), and also checks whether or not the operated portion 17 has been operated in a predetermined manner to start tracking (step S12); if a face has been detected and in addition the operated portion 17 has been operated in a predetermined manner to start tracking, an advance is made to step S13, and the processing in step S13 is executed.

In step S13, based on the image data of an initial setting frame image, the tracking processing portion 51 sets a tracking target and a tracking color. The setting method here is the same as that described in connection with the first embodiment. After the tracking target and the tracking color are set, the loop processing in steps S21 through S23 and S34 is executed repeatedly, and through this loop processing, the tracking processing portion 51 executes tracking processing with respect to a series of tracking target frame images obtained after the tracking target and the tracking color are set. The method for tracking processing here is the same as that described in connection with the first embodiment.

The processing in steps S21 through S23 is the same as that described in connection with the first embodiment. Specifically, in step S21, the current frame image (tracking target frame image) is acquired; subsequently, in step S22, the position and extent of the tracking target in the current frame image are detected by tracking processing, and tracking result information including information indicating the detected position and extent is generated. The tracking result information is outputted to the tracking reliability evaluation portion 52, and to an angle-of-view adjustment portion 63. Subsequently to step S22, in step S23, the tracking reliability evaluation portion 52 calculates a reliability evaluation value EV_{R} and thereby evaluates the tracking reliability at the moment.

In the second embodiment, after the tracking reliability is evaluated in step S23, the processing in step S34 is executed. In step S34, based on the latest tracking result information outputted from the tracking processing portion 51 and the latest tracking reliability evaluated by the tracking reliability evaluation portion 52, the angle-of-view adjustment portion 63 adjusts the angle of view of the image shooting portion 11.

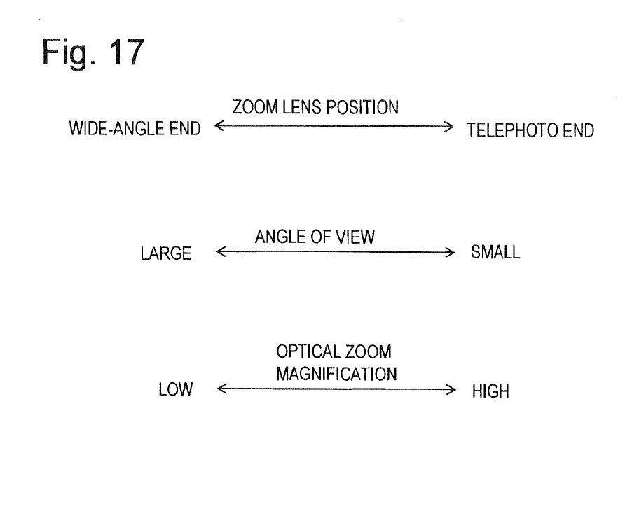

Adjustment of the angle of view is achieved by adjustment of the position of the zoom lens 30 in FIG. 2. The zoom lens 30 is movable along the optical axis within the optical system 35 in FIG. 2. The position of the zoom lens 30 within the optical system 35 is called the zoom lens position. As shown in FIG. 17, as the zoom lens position changes from the wide-angle end to the telephoto end, the angle of view (shooting angle of view) of the image shooting portion 11 decreases and simultaneously the optical zoom magnification increases. The wide-angle and telephoto ends denote the opposite ends of the entire movement range of the zoom lens 30.

Assuming that all the conditions (such as the subject distance) other than the tracking reliability are constant, in step S34, the zoom lens position is so adjusted that, the higher the tracking reliability, the smaller the angle of view. As a result, the higher the tracking reliability, the larger the extent of the tracking target on a frame image (hence the size of the tracking target region).

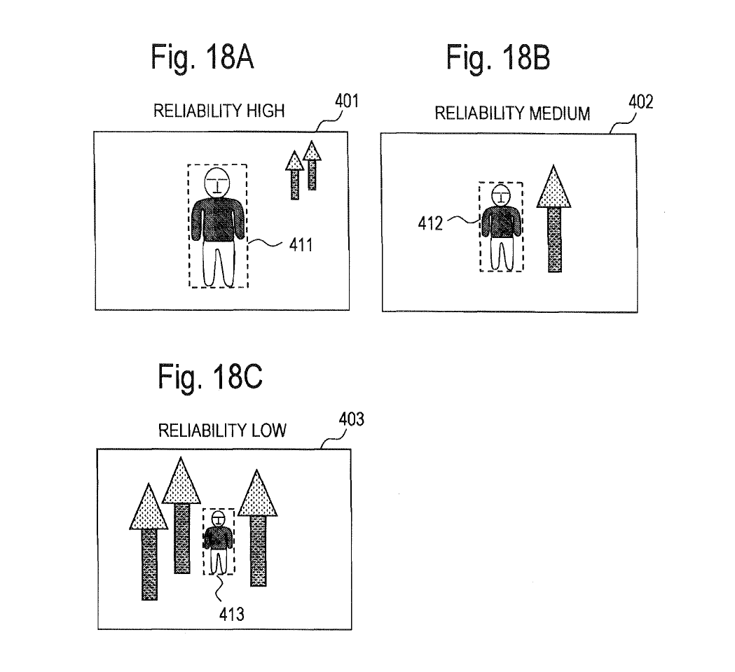

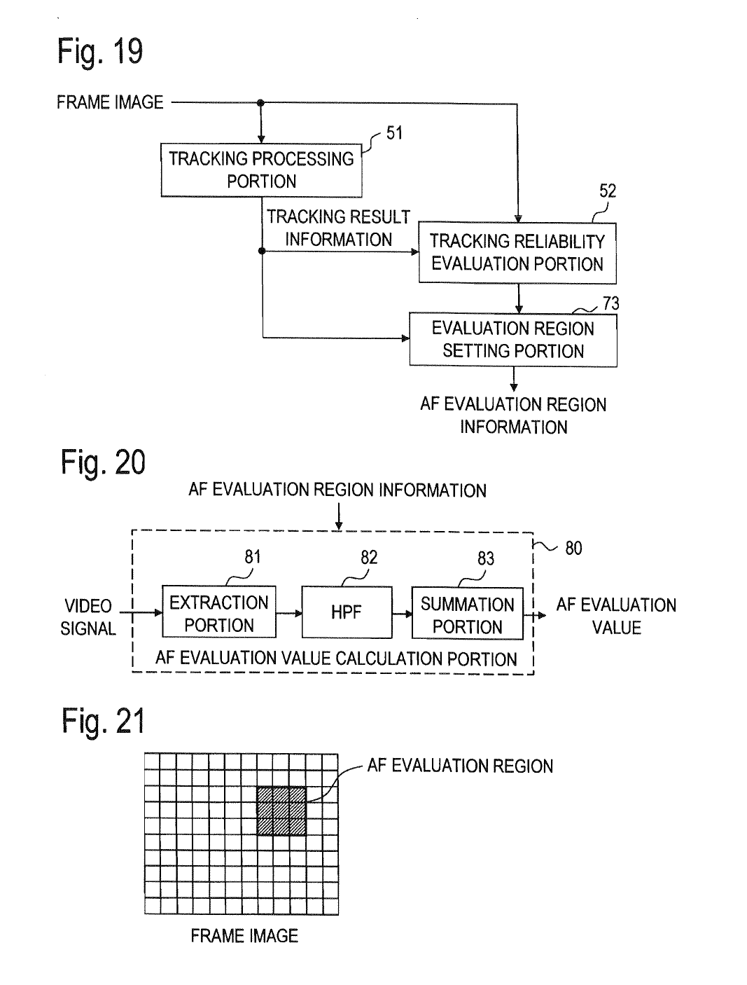

FIGS. 18A, 18B, and 18C show frame images 401, 402, and 403 obtained in cases where the tracking reliability is kept at a first, a second, and a third degree of reliability respectively. It is here assumed that the frame images 401, 402, and 403 are shot with the same subject distance to the tracking target. The subject distance to the tracking target denotes the distance from the image shooting device 1a to the person as the tracking target in the real space.

The broken-line rectangular regions 411, 412, and 413 in FIGS. 18A, 18B, and 18C are the tracking target regions set in the frame images 401, 402, and 403 respectively. It is assumed that, of the first to third degrees of reliability, the first is the highest and the third is the lowest. Due to a color similar to the tracking color of the tracking target being located near the tracking target, the reliability of tracking with respect to the frame images 402 and 403 is lower than that with respect to the frame image 401.

The angle of view of the image shooting portion 11 during the shooting of the frame image 401 is smaller than the angle of view of the image shooting portion 11 during the shooting of the frame image 402, and the angle of view of the image shooting portion 11 during the shooting of the frame image 402 is smaller than the angle of view of the image shooting portion 11 during the shooting of the frame image 403. Thus, in terms of size (image size), of the tracking target regions 411 to 413, the tracking target region 411 is the largest, and the tracking target region 413 is the smallest.

As described above, the angle of view of the image shooting portion 11 is so adjusted that, the higher the reliability of tracking, the larger the extent of the tracking target (hence the extent of the tracking target region) on a frame image. In the case of the examples shown in FIGS. 18A to 18C, based on the tracking result information and the reliability of tracking, the angle of view is adjusted such that, when the reliability of tracking is at the first degree of reliability, the extent of the tracking target (or the extent of the tracking target region 411) on a frame image is a first extent; that, when the reliability of tracking is at the second degree of reliability, the extent of the tracking target (or the extent of the tracking target region 412) on a frame image is a second extent; and that, when the reliability of tracking is at the third degree of reliability, the extent of the tracking target (or the extent of the tracking target region 413) on a frame image is a third extent. Here, it is assumed that, of the first to third extents, the first is the largest, and the third is the smallest.

How to adjust the angle of view can be determined based on size information, included in the tracking result information, of the tracking target. For example, preferably, when the tracking reliability evaluated in step S23 is the first degree of reliability and in addition the extent of the tracking target on the frame image obtained in step S21 is the second extent, the angle of view is adjusted so much as to equivalent to the difference between the first and second extents so that the extent of the tracking target on a frame image obtained next time and later is the first extent. The angle-of-view adjustment portion 63 can determine the amount of angle-of-view adjustment (the amount of movement of the zoom lens 30) equivalent to that difference by referring to a previously set look-up table or the like.

Incidentally, if the tracking target is located in an end portion of the shooting region and thus reducing the angle of view may result in part or all of the tracking target getting out of the shooting region, the angle of view is inhibited from being reduced.

After the processing in step S34, a return is made to step S21, and the above-described loop processing in steps S21 through S23 and S34 is executed repeatedly. A series of chronologically ordered frame images obtained through repetition of this loop processing is displayed as a moving image on the display portion 15, and in addition the image data of the series of frame images is recorded to the recording medium 16. By reading out the image data on the recording medium 16 with an arbitrary image playback device, it is possible to play back and display on it a moving image in a composition good for the tracking target.

By adjusting the angle of view in accordance with the tracking reliability as in this embodiment, it is possible, on one hand, to acquire a moving image in a composition good for a subject of interest and, on the other hand, to prevent, when the tracking reliability is comparatively low, a situation in which the subject of interest does not fall within the shooting region

### Third Embodiment

A third embodiment of the present invention will now be described. The overall block diagram in FIG. 1 applies equally to an image shooting device according to the third embodiment. To distinguish between the image shooting devices according to the first and third embodiments, however, the image shooting device according to the third embodiment will be referred to by the reference sign 1b. The internal configuration shown in FIG. 2 applies equally to the image shooting portion 11 in the image shooting device 1b, and the perspective exterior view in FIG. 3 applies equally to the image shooting device 1b. Unless inconsistent, the image shooting device 1b can realize all the functions realized by the image shooting device according to the first or second embodiment, and, unless inconsistent, all the description given in connection with the first or second embodiment equally applies to the third embodiment.

FIG. 19 is a partial block diagram of the image shooting device 1b, showing those blocks thereof which are related to the operation peculiar to the third embodiment. The tracking processing portion 51, the tracking reliability evaluation portion 52, and the evaluation region setting portion 73 are provided within the main control portion 13 in FIG. 1. The image data of the individual frame images composing a series of frame images is sequentially fed to the tracking processing portion 51 and to the tracking reliability evaluation portion 52. The tracking processing portion 51 and the tracking reliability evaluation portion 52 provided in the image shooting device 1b are the same as those in first embodiment. The tracking result information generated by the tracking processing portion 51 is fed to the tracking reliability evaluation portion 52 and to the evaluation region setting portion 73, and the result of evaluation of the tracking reliability by the tracking reliability evaluation portion 52 is fed to the evaluation region setting portion 73.

An image shooting device according to the present invention, including the image shooting device 1b, can, in the shooting mode, execute automatic focus control (hereinafter referred to as AF control) based on image data.

In AF control, based on the image data within an AF evaluation region set within a frame image, an AF evaluation value is calculated, and, by use of so-called hill-climbing control, the position of the focus lens 31 in FIG. 2 is controlled such that the AF evaluation value takes its greatest value (strictly, a maximum value). This makes it possible to shoot, with focus on a subject appearing within the AF evaluation region, a series of frame images (i.e., a moving image).

The image shooting device 1b executes tracking processing, and also, while setting the position of an AF evaluation region relative to the position of a tracking target on a frame image, varies the size of the AF evaluation region (image size) in accordance with the tracking reliability. A method for this in relation to AF control will now be described in more detail.

First, an AF evaluation value calculation portion 80 for calculating the AF evaluation value will be described. FIG. 20 is an internal block diagram of the AF evaluation value calculation portion 80. The AF evaluation value calculation portion 80 is provided within the main control portion 13 in FIG. 1. The AF evaluation value calculation portion 80 handles a frame image as a calculation target image, and, as described with reference to FIG. 7, divides the entire region of the frame image in the horizontal and vertical directions to thereby set (M×N) small blocks in the entire region of the frame image.

The AF evaluation value calculation portion 80 is provided with an extraction portion 81, a HPF (high-pass filter) 82, and a summation portion 83, and calculates one AF evaluation value for each frame image. The extraction portion 81 receives the video signal of a frame image. The extraction portion 81 extracts luminance signals from the video signal. The HPF 82 extracts from the luminance signals extracted by the extraction portion 81 predetermined high-frequency components. For example, the HPF 82 is formed with a Laplacian filter of a predetermined filter size, and the individual pixels of the frame image are acted upon by the Laplacian filter to perform spatial filtering. Then, the HPF 82 sequentially yields output values in accordance with the filtering characteristics of the Laplacian filter. The summation portion 83 sums up the magnitudes of the high-frequency components extracted by the HPF 82 (i.e., the absolute values of the output values of the HPF 82). The summation is performed for each small block separately, and the sum of the magnitudes of the high-frequency components within a given small block is taken as the block AF value of that small block.

On the other hand, the AF evaluation value calculation portion 80 receives from the evaluation region setting portion 73 in FIG. 19 AF evaluation region information defining the position and extent of an AF evaluation region. From the block AF values of the small blocks belonging to the AF evaluation region according to the AF evaluation region information, the summation portion 83 calculates the AF evaluation value. If only one small block belongs to the AF evaluation region, the block AF value of this small block is itself outputted as the AF evaluation value; if, as shown in FIG. 21, a plurality of small blocks belong to the AF evaluation region, the average of the block AF values of those small blocks is outputted as the AF evaluation value.

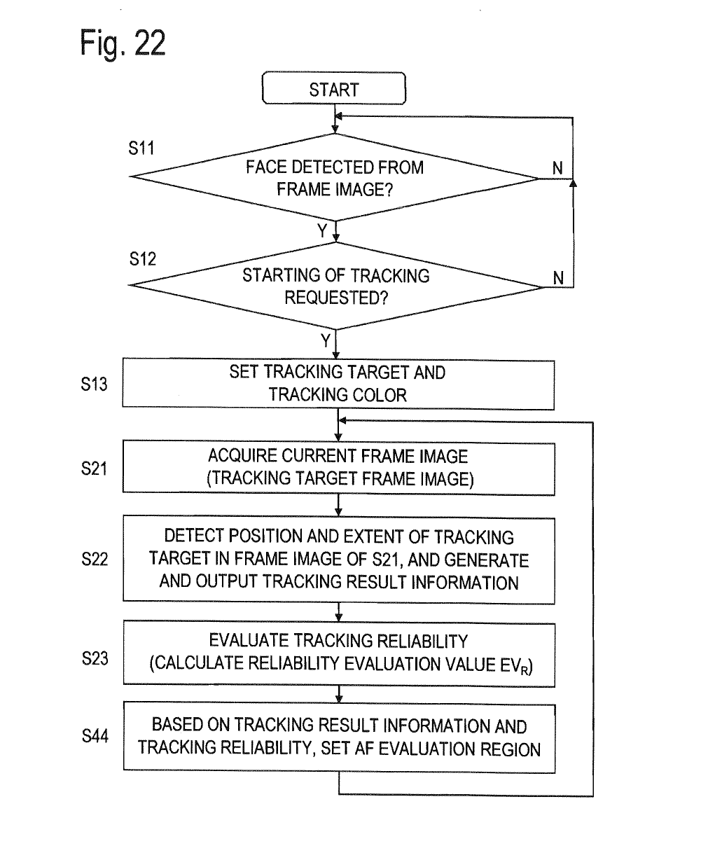

With reference to FIG. 22, a method for setting an AF evaluation region by use of tracking reliability evaluation result will be described. FIG. 22 is a flow chart showing the flow of the operation of the image shooting device 1b in the shooting mode. In the shooting mode, when the subject tracking function is enabled, the tracking processing portion 51 performs face detection processing on the frame images fed sequentially in. The main control portion 13 checks whether or not a face has been detected from the current frame image (step S11), and also checks whether or not the operated portion 17 has been operated in a predetermined manner to start tracking (step S12); if a face has been detected and in addition the operated portion 17 has been operated in a predetermined manner to start tracking, an advance is made to step S13, and the processing in step S13 is executed.

In step S13, based on the image data of an initial setting frame image, the tracking processing portion 51 sets a tracking target and a tracking color. The setting method here is the same as that described in connection with the first embodiment. After the tracking target and the tracking color are set, the loop processing in steps S21 through S23 and S44 is executed repeatedly, and through this loop processing, the tracking processing portion 51 executes tracking processing with respect to a series of tracking target frame images obtained after the tracking target and the tracking color are set. The method for tracking processing here is the same as that described in connection with the first embodiment.

The processing in steps S21 through S23 is the same as that described in connection with the first embodiment. Specifically, in step S21, the current frame image (tracking target frame image) is acquired; subsequently, in step S22, the position and extent of the tracking target in the current frame image are detected by tracking processing, and tracking result information including information indicating the detected position and extent is generated. The tracking result information is outputted to the tracking reliability evaluation portion 52 and to the evaluation region setting portion 73. Subsequently to step S22, in step S23, the tracking reliability evaluation portion 52 calculates a reliability evaluation value EV_{R} and thereby evaluates the tracking reliability at the moment.

In the third embodiment, after the tracking reliability is evaluated in step S23, the processing in step S44 is executed. In step S44, based on the latest tracking result information outputted from the tracking processing portion 51 and the latest tracking reliability evaluated by the tracking reliability evaluation portion 52, the evaluation region setting portion 73 sets an AF evaluation region. This AF evaluation region is set with respect to the latest frame image being obtained at the moment or the next frame image.

The center position of the AF evaluation region is made the same as the center position of the tracking target region in the latest frame image obtained in step S21. On the other hand, while the tracking target region is made to be included in the AF evaluation region based on the extent of the tracking target as defined in the tracking result information, the size of the AF evaluation region is varied in accordance with the tracking reliability. A method for setting the size of the AF evaluation value in accordance with the tracking reliability is similar to the method, described in connection with the first embodiment, for setting the size of the clipping region in accordance with the tracking reliability, and the technology of the first embodiment related to this setting method is applied to this embodiment. In that case, the clipping region in the description of the first embodiment is read as the AF evaluation region. Specifically, for example, assuming that the extent of the tracking target remains constant on the frame images, the size of the AF evaluation region is set such that, as the tracking reliability becomes higher, the size of the AF evaluation region becomes smaller. In practice, preferably, according to the method described with reference to FIG. 10, based on the extent of the tracking target included in the tracking result information and the tracking reliability (EV_{R}), the position and extent of the AF evaluation region are set.

An image shooting device according to the present invention including the image shooting device 1b can, in the shooting mode, execute automatic iris control (hereinafter referred to as AE control) and automatic white balance control (hereinafter referred to as AWB control) based on image data as well, and the method for varying an evaluation region described above with respect to AF control can be applied to AE control and AWB control.

In AE control, the aperture value determined by the aperture size of the aperture stop 32 in FIG. 2, the amplification factor of signal amplification in the AFE 12 (see FIG. 1), and the length of the exposure time for the shooting of a frame image are handled as three AE control targets. From the image data within an AE evaluation region set within a frame image, an AE evaluation value is calculated, and one or more of the three AE control targets are so controlled that the AE evaluation value is kept at or near a predetermined value within a series of frame images, so that the brightness (luminance level) of the image within the AE evaluation region is kept at the desired level of brightness.

An AE evaluation value calculation portion (unillustrated) within the image shooting device 1b calculates one AE evaluation value for each frame image. Taken as the AE evaluation value is the average of the luminance values of the pixels belonging within the AE evaluation region. A luminance value denotes the value of a luminance signal, and, the greater a luminance value, the higher the luminance of the pixel with that luminance value.

In AWB control, from the image data within an AWB evaluation region set within a frame image, an AWB evaluation value is calculated and, based on the AWB evaluation value, the white balance of the entire frame image is adjusted so that the white balance within the AWB evaluation region is the desired white balance. AWB control is achieved, for example, as follows: in the process of generating the mage data of a frame image, the output signal values of the red light-receiving pixels of the image sensing device 33, or the output signal values of the green light-receiving pixels thereof, or the output signal values of the blue light-receiving pixels thereof, or the output signal values of two or more of the groups just mentioned, are multiplied by an AWB coefficients in accordance with the AWB evaluation value.

An AWB evaluation value calculation portion (unillustrated) within the image shooting device 1b calculates one AWB evaluation value for each frame image. The image sensing device 33 shown in FIG. 2 is an image sensing device of a single-panel type, and has color filters arranged in front of its light-receiving pixels. The color filters include red filters that only transmit a red component of light, green filters that only transmit a green component of light, and blue filters that only transmit a blue component of light. The color filters are arranged, for example, in the Bayer arrangement. The light-receiving pixels having red, green, and blue filters arranged in front of them are called red, green, and blue light-receiving pixels respectively. The red, green, and blue light-receiving pixels only respond to the red, green, and blue components, respectively, of the light entering the optical system 35.

A frame image is represented by the output signals of the individual light-receiving pixels of the image sensing device 33, and therefore let us consider that an AWB evaluation region is set on the image sensing surface of the image sensing device 33 as well. The AWB evaluation value calculation portion calculates, as a red evaluation value, the average of the output signal values of the red light-receiving pixels belonging to the AWB evaluation region, calculates, as a green evaluation value, the average of the output signal values of the green light-receiving pixels belonging to the AWB evaluation region, and calculates, as a blue evaluation value, the average of the output signal values of the blue light-receiving pixels belonging to the AWB evaluation region. The AWB evaluation value consists of the red, green, and blue evaluation values.

The camera control parameters to be adjusted when AF control is executed include the position of the focus lens 31; the camera control parameters to be adjusted when AE control is executed include the aperture value, the amplification factor of signal amplification in the AFE 12, and/or the length of the exposure time for the shooting of a frame image; the camera control parameters to be adjusted when AWB control is executed include the AWB coefficients mentioned above. Since a moving image that depends on such camera control parameters is acquired, the camera control parameters determine the conditions for acquisition of the moving image. Specifically, when AF, AE, or AWB control is executed, the conditions for acquisition of a moving image are controlled based on the image data within an AF, AE, or AWB evaluation region (evaluation value collection region) and, for example, this control is executed by an acquisition condition control portion within the main control portion 13.

In cases where a method for varying an evaluation region is applied to AE or AWB control, in step S44 in FIG. 22, based on the latest tracking result information outputted from the tracking processing portion 51 and the latest tracking reliability evaluated by the tracking reliability evaluation portion 52, the evaluation region setting portion 73 sets an AE or AWB evaluation region. This AE or AWB evaluation region is set with respect to the latest frame image being obtained at the moment or the next frame image.

The center position of the AE or AWB evaluation region is made the same as the center position of the tracking target region in the latest frame image obtained in step S21. On the other hand, while the tracking target region is made to be included in the AE or AWB evaluation region based on the extent of the tracking target as defined in the tracking result information, the size of the AE or AWB evaluation region is varied in accordance with the tracking reliability. A method for setting the size of the AE or AWB evaluation value in accordance with the tracking reliability is similar to the method, described in connection with the first embodiment, for setting the size of the clipping region in accordance with the tracking reliability, and the technology of the first embodiment related to this setting method is applied to this embodiment. In that case, the clipping region in the description of the first embodiment is read as the AE or AWB evaluation region. Specifically, for example, assuming that the extent of the tracking target remains constant on the frame images, the size of the AE or AWB evaluation region is set such that, as the tracking reliability becomes higher, the size of the AE or AWB evaluation region becomes smaller. In practice, preferably, according to the method described with reference to FIG. 10, based on the extent of the tracking target included in the tracking result information and the tracking reliability (EV_{R}), the position and extent of the AE or AWB evaluation region are set.

After the processing in step S44, a return is made to step S21, and the above-described loop processing in steps S21 through S23 and S44 is executed repeatedly. A series of chronologically ordered frame images obtained through repetition of this loop processing is displayed as a moving image on the display portion 15, and in addition the image data of the series of frame images is recorded to the recording medium 16.

When the tracking reliability is comparatively low, it is fairly likely that an object different from a true tracking target is erroneously detected as a tracking target. Accordingly, when the tracking reliability is comparatively low, setting a small AF, AE, or AWB evaluation region as when the tracking reliability is comparatively high may create a situation in which focusing, image brightness adjustment, or white balance adjustment is performed on a background quite unrelated to a subject of interest. In view of this, according to this embodiment, the size of an AF, AE, or AWB evaluation region is varied in accordance with the tracking reliability. This makes it possible to avoid such a situation.

### Fourth Embodiment

A fourth embodiment of the present invention will now be described. The overall block diagram in FIG. 1 applies equally to an image shooting device according to the fourth embodiment. To distinguish between the image shooting devices according to the first and fourth embodiments, however, the image shooting device according to the fourth embodiment will be referred to by the reference sign Ic. The internal configuration shown in FIG. 2 applies equally to the image shooting portion 11 in the image shooting device 1c, and the perspective exterior view in FIG. 3 applies equally to the image shooting device 1c. Unless inconsistent, the image shooting device 1c can realize all the functions realized by the image shooting device according to the first or second embodiment, and, unless inconsistent, all the description given in connection with the first or second embodiment equally applies to the fourth embodiment.

The image shooting device 1c can, in time of image playback, execute control (hereinafter referred to as in-time-of-playback AE control) similar to the AE control described in connection with the third embodiment and control (hereinafter referred to as in-time-of-playback AWB control) similar to the AWB control in connection with the third embodiment. Here, it is assumed that, prior to such image playback operation, the image data of an entire series of chronologically ordered frame images obtained during shooting of a moving image is recorded on the recording medium 16. The operation described below in connection with this embodiment is that of the image shooting device 1c in the playback mode.

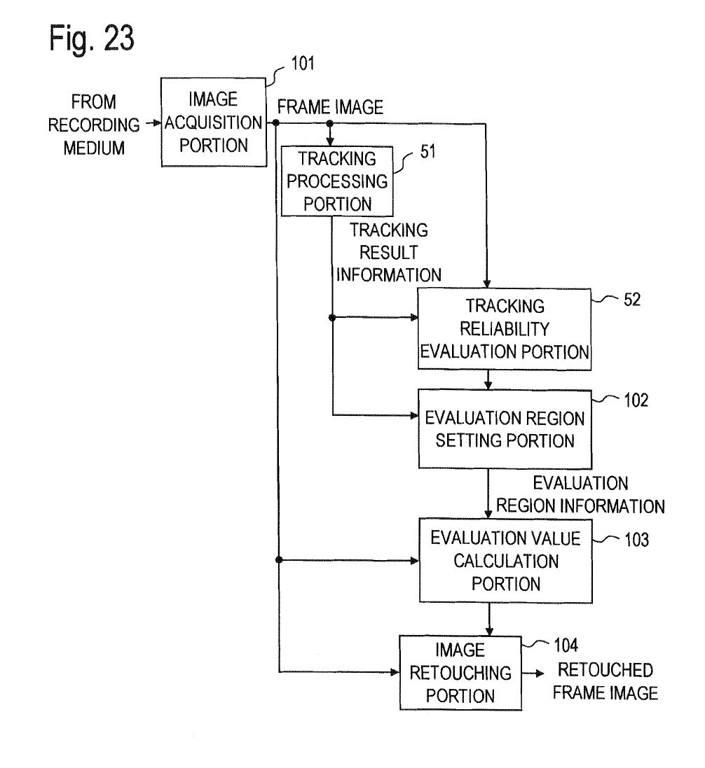

FIG. 23 is a partial block diagram of the image shooting device 1c, showing those blocks thereof which are related to the operation peculiar to the fourth embodiment. The blocks identified by the reference signs 51, 52, and 101 to 104 in FIG. 23 are provided within the main control portion 13 in FIG. 1. An image acquisition portion 101 reads out, sequentially in chronological order, frame images from the recording medium 16, and feeds the image data of those frame images, in chronological order, to a tracking processing portion 51, to a tracking reliability evaluation portion 52, to an evaluation value calculation portion 103, and to an image retouching portion 104. The tracking processing portion 51 and the tracking reliability evaluation portion 52 provided in the image shooting device 1c are the same as those in first embodiment. The tracking result information generated by the tracking processing portion 51 is fed to the tracking reliability evaluation portion 52 and to an evaluation region setting portion 102, and the result of evaluation of the tracking reliability by the tracking reliability evaluation portion 52 is fed to the evaluation region setting portion 102.

The tracking processing portion 51 takes as an initial setting frame image the frame image fed thereto at the time point that the operated portion 17 is operated in a predetermined manner to start tracking, and based on the image data of the initial setting frame image sets a tracking target and a tracking color. It is here assumed that a person to be taken as a tracking target appears in the initial setting frame image. The method for setting the tracking target and the tracking color here is the same as that described in connection with the first embodiment.

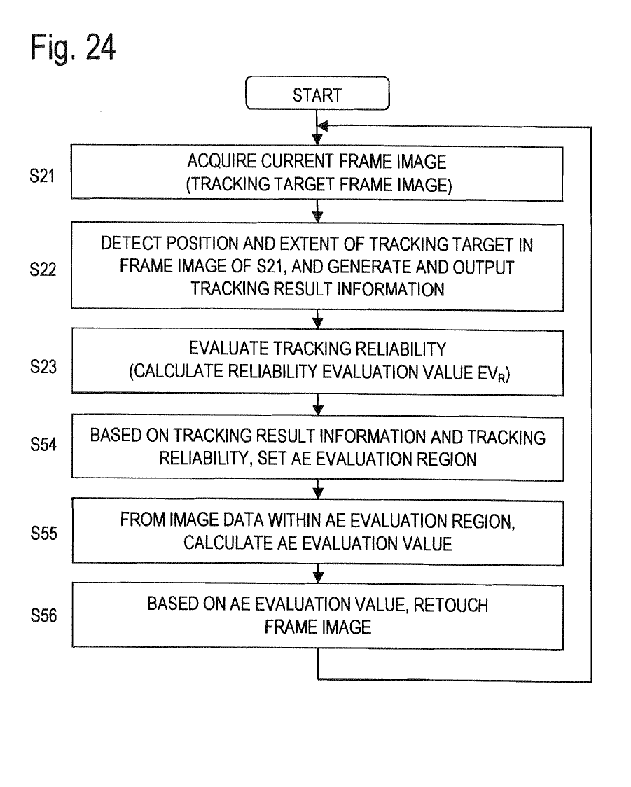

After the tracking target and the tracking color are set, operation according to the flow chart in FIG. 24 is executed. FIG. 24 is a flow chart showing the operation procedure for in-time-of-playback AE control.

After the tracking target and the tracking color are set, the loop processing in steps S21 through S23 and S54 through S56 is executed repeatedly, and, through this loop processing, the tracking processing portion 51 executes tracking processing with respect to a series of tracking target frame images obtained after the tracking target and the tracking color are set. The method for tracking processing here is the same as that described in connection with the first embodiment.

The processing in steps S21 through S23 is the same as that described in connection with the first embodiment. Specifically, in step S21, the current frame image (tracking target frame image) is acquired; subsequently, in step S22, the position and extent of the tracking target in the current frame image are detected by tracking processing, and tracking result information including information indicating the detected position and extent is generated. The tracking result information is outputted to the tracking reliability evaluation portion 52 and to evaluation region setting portion 102. Subsequently to step S22, in step S23, the tracking reliability evaluation portion 52 calculates a reliability evaluation value EV_{R} and thereby evaluates the tracking reliability at the moment.

In in-time-of-playback AE control, after the tracking reliability is evaluated in step S23, the processing in step S54 is executed. In step S54, based on the latest tracking result information outputted from the tracking processing portion 51 and the latest tracking reliability evaluated by the tracking reliability evaluation portion 52, the evaluation region setting portion 102 sets an AE evaluation region. This AE evaluation region is set with respect to the latest frame image obtained in step S21.

The center position of the AE evaluation region is made the same as the center position of the tracking target region in the latest frame image obtained in step S21. On the other hand, while the tracking target region is made to be included in the AE evaluation region based on the extent of the tracking target as defined in the tracking result information, the size of the AE evaluation region is varied in accordance with the tracking reliability. A method for setting the size of the AE evaluation value in accordance with the tracking reliability is similar to the method, described in connection with the first embodiment, for setting the size of the clipping region in accordance with the tracking reliability, and the technology of the first embodiment related to this setting method is applied to this embodiment. In that case, the clipping region in the description of the first embodiment is read as the AE evaluation region. Specifically, for example, assuming that the extent of the tracking target remains constant on the frame images, the size of the AE evaluation regions is set such that, as the tracking reliability becomes higher, the size of the AE evaluation region becomes smaller. In practice, preferably, according to the method described with reference to FIG. 10, based on the extent of the tracking target included in the tracking result information and the tracking reliability (EV_{R}), the position and extent of the AE evaluation region are set.

Subsequently to step S54, in step S55, the evaluation value calculation portion 103 applies the AE evaluation region set in step S54 to the frame image acquired in step S21, and calculates from the image data within the AE evaluation region of the frame image the AE evaluation value with respect to the frame image. The method for calculating the AE evaluation value is the same as that described in connection with third embodiment.

Thereafter, in step S56, the image retouching portion 104 retouches the frame image acquired in step S21 based on the AE evaluation value calculated in step S55, and thereby generates a retouched frame image. In in-time-of-playback AE control, the luminance values of the individual pixels of the frame image acquired in step S21 are multiplied by a fixed value in accordance with the AE evaluation value, and the resulting image is taken as the retouched frame image. This keeps the brightness (luminance level) of the image within the AE evaluation region including the tracking target region at the desired level of brightness.

After the processing in step S56, a return is made to the step S21, so that the loop processing in steps S21 through S23 and S54 through S56 is performed repeatedly. A series of chronologically ordered retouched frame images obtained through repetition of this loop processing is displayed as a moving image on the display portion 15. The image data of the series of retouched frame images may be recorded to the recording medium 16.

Although the above description deals with the operation when in-time-of-playback AE control is performed, in-time-of-playback AWB control is realized likewise by executing the processing in steps S21 through S23 and S54 through S56. In a case where in-time-of-playback AWB control is performed, however, the AE evaluation region and the AE evaluation value in the above description are read as the AWB evaluation region and the AWB evaluation value. The AWB evaluation value is calculated based on the image data within the AWB evaluation region on a frame image, and, in step S56, the frame image is retouched based on the AWB evaluation value. In in-time-of-playback AWB control, the white balance of an entire frame image is adjusted based on the AWB evaluation value such that the white balance within the AWB evaluation region is the desired white balance. The frame image after white balance adjustment is the retouched frame image to be generated by the image retouching portion 104.

When the tracking reliability is comparatively low, it is fairly likely that an object different from a true tracking target is erroneously detected as a tracking target. Accordingly, when the tracking reliability is comparatively low, setting a small AE or AWB evaluation region as when the tracking reliability is comparatively high may create a situation in which image brightness adjustment or white balance adjustment is performed with focus on a background quite unrelated to a subject of interest. In view of this, according to this embodiment, the size of an AE or AWB evaluation region is varied in accordance with the tracking reliability. This makes it possible to avoid such a situation.

In the example described above, a series of retouched frame images is played back and displayed on the display portion 15 provided in the image shooting device 1c. Instead, the image data of images to be displayed may be fed to a display device (unillustrated) external to the image shooting device 1c to display on that external display device a series of retouched frame images. It is also possible to feed, as necessary, the image data of a series of retouched frame images over a network or the like to an external device (such as a server device administering a web site) that uses the image data.

### Fifth Embodiment

A fifth embodiment of the present invention will now be described. The embodiments described above deal with a method for tracking processing based on color information. The tracking processing portion 51 shown in FIG. 4 etc., however, can adopt another arbitrary method for tracking processing. An embodiment exemplifying another method for tracking processing will now be described as a fifth embodiment. The features that will be described in connection with the fifth embodiment are implemented in combination with the first to fourth embodiments described above.

For example, the tracking processing portion 51 can execute tracking of the position of a tracking target in a series of frame images by use of image matching. Although tracking processing using image matching is known, a brief description will now be given of tracking processing based on image matching (template matching) between a frame image at time point tₙ₋₁ and a frame image at time point tₙ. It is assumed that the position of a tracking target on the frame image at time point tₙ₋₁ has already been detected. As described in connection with the first embodiment, first the frame image at time point tₙ₋₁ and next the frame image at time point tₙ is shot (see FIG. 14).

The tracking processing portion 51 takes as of interest an image region that is a partial region within the entire region of the frame image at time point tₙ₋₁ and where part or all of the tracking target appears. The image within that image region of interest is taken as a template image, and a tracking frame is set within the frame image at time point tₙ. It then executes evaluation of similarity between the image within the tracking frame and the template image while moving the tracking frame from one position to another within the search range, and judges that the tracking target on the frame image at time point tₙ is located at the position of the tracking frame at which the greatest similarity (in other words, the smallest different) is obtained. The search range with respect to the frame image at time point tₙ is set relative to the position of the tracking target in the frame image at time point tₙ₋₁. Usually, the search range is a rectangular region centered at the position of the tracking target in the frame image at time point tₙ₋₁, and the size (image size) of the search range is smaller than the size of the entire region of a frame image.

In a case where the tracking processing portion 51 performs tracking processing by use of image matching, the method by which the tracking reliability evaluation portion 52 calculates the reliability evaluation value EV_{R} is changed from the one described in connection with the first embodiment. A method for calculating the reliability evaluation value EV_{R} which fits tracking processing using image matching will now be described.

The tracking reliability evaluation portion 52 handles each frame image as a calculation target image. By the method described in connection with the first embodiment, small blocks are set within the calculation target image, and the small blocks are classified into subject blocks and background blocks, so that the entire region of each frame image is divided into a tracking target region and a background region (see FIG. 7). The small block where the above-mentioned template image is located is handled as the small block [m_{O}, n_{O}], and, for each background block, a difference evaluation value is calculated that represents the difference between the image within the small block [m_{O}, n_{O}] in the frame image at time point tₙ and the image of the background block in the frame image at time point tₙ.

Suppose that there are Q of the background blocks, and the difference evaluation values calculated with respect to the first to Qth background blocks are represented by C_{DISA}[1] to C_{DISA}[Q] respectively (where Q is an integer fulfilling the inequality “2≦Q≦(M×N)—1.” For example, taken as the difference evaluation value C_{DISA}[i] with respect to the frame image at time point tₙ is a SAD (sum of absolute difference) or SSD (sum of square difference) found by comparison of the pixel values (for example, luminance values) of the pixels belonging to the small block [m_{O}, n_{O}] in the frame image at time point tₙ with the values (for example, luminance values) of the pixels belonging to the ith background block in the frame image at time point tₙ (where i is a natural number). Thus, the greater the difference between the compared images, the greater the difference evaluation value C_{DISA}[i]. Here, it is assumed that the difference evaluation value is normalized such that the difference evaluation value C_{DISA}[i] takes a value in the range of 0 or more but 1 or less. Needless to say, with respect to a given image region of interest, the pixel values (for example, luminance values) of the pixels belonging to the image region are one kind of quantity representing the image within that image region (image characteristic quantity).

On the other hand, the center of the small block [m_{O}, n_{O}] is handled as the center 250 described with reference to FIG. 8, and, by the same method as that described in connection with the first embodiment, the position difference evaluation values P_{DIS}[1] to P_{DIS}[Q] with respect to the first to Qth background blocks are found. Then, the difference evaluation value C_{DISA}[i] is substituted in C_{DIS}[i] and, according to formula (1) above, the integrated distance CP_{DIS} is calculated; then, by use of the integrated distance CP_{DIS}, according to formula (2) above, the reliability evaluation value EV_{R} with respect to the calculation target image of interest (in the example under discussion, the frame image at time point tₙ) is calculated. As will be understood from the calculation method here, if a pattern similar to the pattern of the tracking target is present near the tracking target, the reliability evaluation value EV_{R} is low.

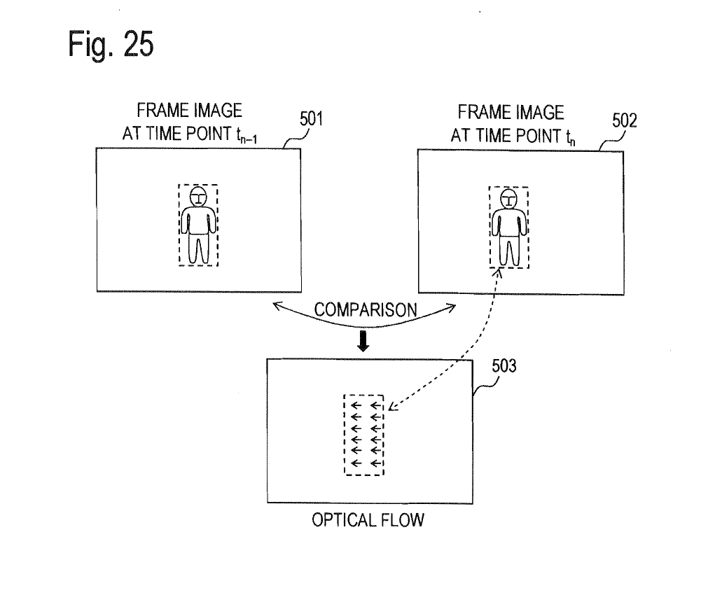

The tracking processing portion 51 can execute tracking of the position of a tracking target in a series of frame images not by image matching but by use of optical flow information. Though tracking processing using optical flow information is known, a brief description will now be given of tracking processing based on optical flow information between a frame image at time point tₙ₋₁ and a frame image at time point tₙ. Here, it is assumed that the position of the tracking target on the frame image at time point tₙ₋₁ has already been detected. FIG. 25 shows the frame images 501 and 502 at time points tₙ₋₁ and tₙ and the optical flow 503 between the two images. The solid-line arrows inside the optical flow 503 represent the motion vector corresponding to the movement of the tracking target.

The tracking processing portion 51 compares the frame images at time points tₙ₋₁ and tₙ, and thereby determines the optical flow between the compared images. The optical flow is a bundle of motion vectors expressing the movement of an object between compared images as observed on the images and as expressed in vectors, and is derived by a representative point matching method, a block matching method, a gradient method, or the like. The tracking processing portion 51 searches the bundle of motion vectors for a group of motion vectors having a substantially identical direction and a substantially identical magnitude, and judges that a mobile object as the tracking target is located where that group of motion vector is located (that is, it judges that that position is the position where the tracking target is located on the frame image at time point tₙ). The search is performed within a search range, and the search range with respect to the frame image at time point tₙ is set relative to the position of the tracking target on the frame image at time point tₙ₋₁. Usually, the search range is a rectangular region centered at the position of the tracking target on the frame image at time point tₙ₋₁, and the size (image size) of the search range is smaller than the size of the entire region of a frame image. It is also possible to set a tracking target region based on the range in which the group of motion vectors found is located.

In a case where the tracking processing portion 51 performs tracking processing by use of optical flow information, the method by which the tracking reliability evaluation portion 52 calculates the reliability evaluation value EV_{R} is changed from the one described in connection with the first embodiment. A method for calculating the reliability evaluation value EV_{R} which fits tracking processing using optical flow information will now be described.

The tracking reliability evaluation portion 52 handles each frame image as a calculation target image. By the method described in connection with the first embodiment, small blocks are set within the calculation target image, and the small blocks are classified into subject blocks and background blocks, so that the entire region of each frame image is divided into a tracking target region and a background region (see FIG. 7). Suppose now that the optical flow between the frame images at time points tₙ₋₁ and tₙ is the optical flow with respect to the frame image at time point tₙ. The small block where the tracking target (the center of the tracking target) is located on the frame image at time point tₙ is handled as the small block [m_{O}, n_{O}], and, for each background block, a difference evaluation value is calculated that represents the difference between the optical flow within the small block [m_{O}, n_{O}] with respect to the frame image at time point tₙ and the optical flow within the background block with respect to the frame image at time point tₙ.

Suppose that there are Q of the background blocks, and the motion difference evaluation values calculated with respect to the first to Qth background blocks are represented by C_{DISB}[1] to C_{DISB}[Q] respectively (where Q is an integer fulfilling the inequality “2≦Q≦(M×N)−1.” The optical flow within the small block [m_{O}, n_{O}] with respect to the frame image at time point tₙ and the optical flow within the ith background block with respect to the frame image at time point tₙ are called the first and second optical flows respectively. Then, for example, based on the result of comparison of the directions and magnitudes of the motion vectors forming the first optical flow with the directions and magnitudes of the motion vectors forming the second optical flow, the motion difference evaluation value C_{DISB}[i] with respect to the frame image at time point tₙ is calculated such that it is greater the greater the difference between the compared directions is and the greater the difference between the compared magnitudes is (where i is a natural number). Here, it is assumed that the motion difference evaluation value is normalized such that the motion difference evaluation value C_{DISB}[i] takes a value in the range of 0 or more but 1 or less. With respect to a given image region of interest, the optical flow derived with respect to that image region can be taken as one kind of quantity representing a motion-related characteristic of the image within that image region (image characteristic quantity).

On the other hand, the center of the small block [m_{O}, n_{O}] is handled as the center 250 described with reference to FIG. 8, and, by the same method as that described in connection with the first embodiment, the position difference evaluation values P_{DIS}[1] to P_{DIS}[Q] with respect to the first to Qth background blocks are found. Then, the motion difference evaluation value C_{DISB}[i] is substituted in C_{DIS}[i] and, according to formula (1) above, the integrated distance CP_{DIS} is calculated; then, by use of the integrated distance CP_{DIS}, according to formula (2) above, the reliability evaluation value EV_{R} with respect to the calculation target image of interest (in the example under discussion, the frame image at time point tₙ) is calculated. As will be understood from the calculation method here, if a mobile object that moves similarly to the tracking target is present near the tracking target, the reliability evaluation value EV_{R} is low.

### Sixth Embodiment

A sixth embodiment of the present invention will now be described. The sixth embodiment deals with another modified example of the method for deriving the tracking reliability, that is, another modified example of the method for calculating the reliability evaluation value EV_{R}. The features that will be described in connection with the sixth embodiment are implemented in combination with the embodiments described above.

Presented below will be ten, i.e., a first to a tenth, calculation methods as methods for calculating the reliability evaluation value EV_{R}. The tracking reliability evaluation portion 52 shown FIG. 4 etc. can calculate the reliability evaluation value EV_{R} with respect to a calculation target image (i.e., a tracking target frame image with respect to which to calculate the reliability evaluation value EV_{R}) by use of one of the first to tenth calculation methods.

In the first embodiment, it is assumed that the reliability evaluation value EV_{R} takes a value of 0 or more but 100 or less; by contrast, in the sixth embodiment, it is assumed that the reliability evaluation value EV_{R} takes a value of 0 or more but 1 or less, and that the higher the tracking reliability is evaluated to be, the closer the reliability evaluation value EV_{R} is to the upper limit of 1. Accordingly, in cases where the calculation methods of the sixth embodiment are applied to the embodiments described above, the reliability evaluation values EV_{R} calculated by the calculation methods of the sixth embodiment are multiplied by 100.

First Calculation Method: A first calculation method will now be described. In connection with the first embodiment, the following tracking processing is described: After a tracking color is set, a search range and a tracking frame are set within a tracking target frame image as a calculation target image; then, while the position of the tracking frame is moved from one position to another within the search range, similarity between the color of the image within the tracking frame and the tracking color is evaluated, and thereby the position of the tracking target on the tracking target frame image is detected. The search range for the current tracking target frame image is set relative to the position of the tracking target in the previous tracking target frame image.

In such tracking processing, if the extent of the tracking target on the tracking target frame image is small, the stability of tracking is low. For example, in a case where an object of a similar color to the tracking color (the object being different from the tracking target) is within the search range, even if that object is comparatively small, if the extent of the tracking target is comparatively small, it is fairly likely that the object is erroneously detected as the tracking target. By contrast, if the extent of the tracking target is comparatively large, irrespective of the presence of the object, erroneous detection is unlikely.

In view of the foregoing, in the first calculation method, the reliability evaluation value EV_{R} is calculated based on the extent of the tracking target on the calculation target image. Specifically, the reliability evaluation value EV_{R} with respect to the calculation target image is calculated according to formula (6-1) below.

EV_{R}=TgtSize/AreaSize (6-1)

Here, TgtSize represents a value indicating the extent of the image region where the image data of the tracking target is judged to be located in the calculation target image, and AreaSize represents a value indicating the extent of the search range in the calculation target image.

The extent TgtSize can be expressed in terms of number of pixels. Specifically, for example, of the pixels belonging to the search range, the total number of pixels representing the image data of the tracking target can be substituted in TgtSize. As described in connection with the first embodiment, based on the tracking result information, the image region of a calculation target image can be divided into a tracking target region where the image data of the tracking target appears and a background region where the image data of the background appears; the total number of pixels belonging to this tracking target region can be substituted in TgtSize. In a case where TgtSize is expressed in terms of number of pixels, taken as AreaSize is the total number of pixels belonging to the search range.

Alternatively, the extent TgtSize may be expressed in terms of area on an image. Specifically, in tracking processing, the exterior shape of the tracking target can be approximated to a comparatively simple shape (for example, an ellipse or a rectangle), and TgtSize may be expressed in terms of the area within the exterior shape of the tracking target as obtained by such approximation. Specifically, for example, the area of the tracking target region on the calculation target image can be substituted in TgtSize. Although the exterior shape of the tracking target region is rectangular in the first embodiment, it may be any shape other than rectangular. In a case where TgtSize is expressed in terms of area, taken as AreaSize is the area of the search range on the calculation target image.

Second Calculation Method: A second calculation method will now be described. In the second calculation method, the reliability evaluation value EV_{R} is calculated based on the position of the tracking target on the calculation target image. Specifically, the reliability evaluation value EV_{R} with respect to the calculation target image is calculated according to formula (6-2) below. When the right side of formula (6-2) is negative, however, EV_{R} is made equal to zero.

EV_{R}=1−(TDist/StdDist) (6-2)

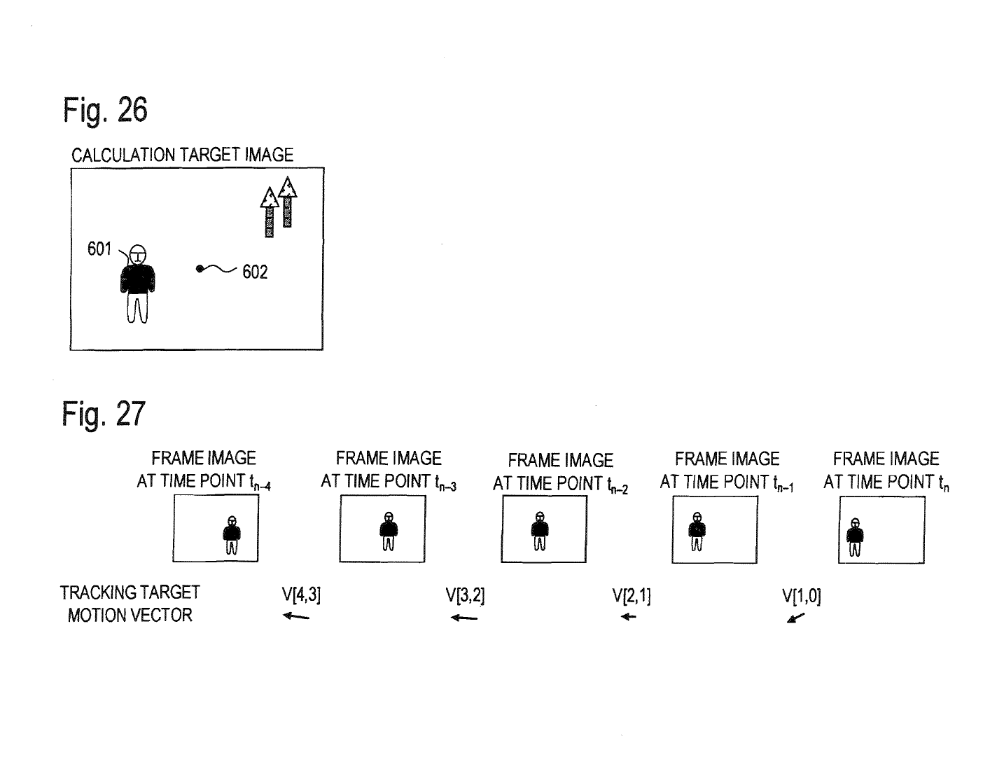

As shown in FIG. 26, TDist represents the distance between the center position 601 of the tracking target and the center position 602 of the calculation target image (i.e., the spatial position difference between the positions 601 and 602 on the calculation target image), and StdDist represents a previously set reference distance. The center position 601 of the tracking target is, for example, the position of the center 250, described in connection with the first embodiment, based on the tracking result information with respect to the calculation target image (see FIG. 8).

A user usually operates the image shooting device so that a subject of interest to be taken as a tracking target is located near the center of an image. Accordingly, a tracking result in which the tracking target is detected at an edge portion of an image has dubious reliability. Moreover, in a case where the tracking target is in an edge part of an image, the tracking target is likely to fall outside the shooting region of the image shooting device (it is likely to get “out of frame”). In such a case, from the viewpoint of maintaining tracking, it is important to lower the tracking reliability to increase the shooting angle of view. Out of these considerations, in the second calculation method, the closer the position of the tracking target is judged to be to the center of an image, the greater the reliability evaluation value EV_{R} is made; when the opposite is the case, the smaller the reliability evaluation value EV_{R} is made.

Third Calculation Method: A third calculation method will now be described. In the third calculation method, the reliability evaluation value EV_{R} is calculated based on the magnitude of the motion vector of a tracking target between different tracking target frame images. Specifically, the reliability evaluation value EV_{R} with respect to the calculation target image is calculated according to formula (6-3) below. When the right side of formula (6-3) is negative, however, EV_{R} is made equal to zero.

EV_{R}=1−(|Vt|/|Vstd|) (6-3)

Vt represents the motion vector of a tracking target between a first tracking target frame image as a calculation target image and a second tracking target frame image shot prior to the first tracking target frame image, and |Vt| represents the magnitude of the motion vector Vt. Vstd represents a previously set reference vector, and I Vstd I represents the magnitude of the reference vector Vstd.

The motion vector Vt is a vector representing the position of the tracking target on the first tracking target frame image as seen from the position of the tracking target on the second tracking target frame image (i.e., the motion vector Vt is a motion vector relative to the second tracking target frame image as a reference image). The positions of the tracking target on the first and second tracking target frame images denote, for example, the positions of the center 250 on the first and second tracking target frame images according to the tracking result information with respect to the first and second tracking target frame images respectively (see FIG. 8). The second tracking target frame image is a frame image shot n frame periods before the first tracking target frame image (where n is an integer of 1 or more). Alternatively, a plurality of frame images shot prior to the first tracking target frame image may each be taken as a second tracking target frame image so that the average of the motion vector of the tracking target between each of those frame images and the first tracking target frame image may be taken as Vt.

If a tracking result is obtained in which the position of the tracking target changes sharply during an evaluation period, which is the shooting interval between the first and second tracking target frame images, the tracking result has dubious reliability. Moreover, if the tracking target moves fast, it is likely to get out of frame, and, in tracking processing, it is easy to lose. Out of these considerations, in the third calculation method, the reliability evaluation value EV_{R} is calculated based on the magnitude of the motion vector of the tracking target.

Fourth Calculation Method: A fourth calculation method will now be described. In the fourth calculation method, the reliability evaluation value EV_{R} is calculated based on the angle θ formed by the motion vector Vt of the tracking target and the reference vector Vstd, which were mentioned in connection with the third calculation method. In the fourth calculation method, however, the motion vector Vt is the motion vector of the tracking target between a first tracking target frame image as a calculation target image and a tracking target frame image shot one frame period before the first tracking target frame image, and the reference vector Vstd is a motion vector of the tracking target obtained further before.

Now, with reference to FIG. 27, a supplemental description will be given of the significances of the motion vector Vt and the reference vector Vstd in the fourth calculation method. Suppose now that, every time the period of one frame passes, time points tₙ₋₄, tₙ₋₃, tₙ₋₂, tₙ₋₁, tₙ, . . . occur in this order. The tracking target frame image obtained at time point tₙ₋ᵢ is called the tracking target frame image at time point tₙ₋ᵢ, or simply the frame image at time point tₙ₋ᵢ (where i is an integer). Moreover, the motion vector of the tracking target between the frame images at time points tₙ₋ᵢ and tₙ₋₍ᵢ₋₁₎ with reference to the frame image at time point tₙ₋ᵢ is represented by V[i, i−1] as shown in FIG. 27.

Under these assumptions, if the calculation target image with respect to which to calculate the reliability evaluation value EV_{R} is the frame image at time point tₙ, the motion vector Vt in the fourth calculation method is a vector V[1, 0], and the reference vector Vstd in the fourth calculation method is a vector V[2, 1]. Alternatively, the reference vector Vstd may be an average vector of the vector V[2, 1] and one or more motion vectors calculated with respect to the tracking target before the vector V[2, 1] (for example, the average vector of V[2, 1] and V[3, 2]).

By use of the vectors Vt and Vstd mentioned above, the reliability evaluation value EV_{R} with respect to the calculation target image is calculated according to formula (6-4) below.

$$\begin{matrix}{EV}_{R} = ( 1 + cos θ ) / 2 \\ = ( 1 + ( Vt \cdot Vstd ) / ( \vert Vt \vert \times \vert Vstd \vert ) ) / 2\end{matrix} \qquad ( 6 \text{-} 4 )$$

The direction of the motion vector Vt represents the direction of the latest movement of the tracking target on an image, and the direction of the reference vector Vstd represents the direction of a past movement of the tracking target on an image. When the tracking target moves on a moving image, in most cases, the direction of the movement is largely constant. Thus, a tracking result in which the direction of movement changes sharply has dubious reliability. In view of this, in the fourth calculation method, when the above-mentioned angle θ is comparatively large, the reliability evaluation value EV_{R} is made comparatively small and, when the above-mentioned angle θ is comparatively small, the reliability evaluation value EV_{R} is made comparatively great.

Fifth Calculation Method: A fifth calculation method will now be described. The fifth calculation method is a combination of the third and fourth calculation methods. Specifically, in the fifth calculation method, the reliability evaluation value EV_{R} with respect to the calculation target image is calculated according to formula (6-5) below. Here, EV_{R4} represents the EV_{R} to be calculated according to formula (6-3) above, and EV_{R5} represents the EV_{R} to be calculated according to formula (6-4) above.

EV_{R}=EV_{R4}×EV_{R5} (6-5)

Sixth Calculation Method: A sixth calculation method will now be described. In the sixth calculation method, the reliability evaluation value EV_{R} is calculated based on the frame-to-frame correlation of a characteristic quantity obtained from the pixels classified as the tracking target (in other words, based on the variation of a characteristic quantity of the tracking target from one frame to another). Specifically, the reliability evaluation value EV_{R} with respect to the calculation target image is calculated according to formula (6-6) below. When the right side of formula (6-6) is negative, however, EV_{R} is made equal to zero.

EV_{R}=1−(|VAL(n)−VAL(n−1)|)/VALbase (6-6)

Here, VAL(n) represents the characteristic quantity with respect to the nth tracking target frame image (i.e., the frame image at time point tₙ shown in FIG. 27), VAL(n−1) represents the characteristic quantity with respect to the (n−1)th tracking target frame image (i.e., the frame image at time point tₙ₋₁ shown in FIG. 27), and VALbase represents a previously set reference characteristic quantity.

As described above, based on the tracking result information, the entire region of each tracking target frame image is divided into a tracking target region where the image data of the tracking target appears and a background region where the image data of the background appears. Here, the characteristic quantity of the tracking target region in the ith tracking target frame image is VAL(i) (here i is either n or (n−1)).

The characteristic quantity VAL(i) may be a characteristic quantity of the same kind as that used for detecting a tracking target in tracking processing. Specifically, for example, in a case where a body region of a tracking target is tracked based on color information as described in connection with the first embodiment, the color of the body region in the ith tracking target frame image (hereinafter referred to as the ith characteristic color) is found based on the image data of the body region in the ith tracking target frame image. The method, described in connection with the first embodiment, for deriving a tracking color based on the image data of an initial setting frame image can be used as a method for deriving the ith characteristic color based on the image data of the ith tracking target frame image. Then the position of the ith characteristic color on a color space (for example, the RGB or HSV color space) is taken as VAL(i). In this case, |VAL(n)−VAL(n−1)| in formula (6-6) is the distance between the nth characteristic color and the (n−1)th characteristic color on the color space.

The characteristic quantity VAL(i) may be a characteristic quantity of a different kind from that used for detecting a tracking target in tracking processing. Specifically, for example, in a case where a body region of a tracking target is tracked based on color information as described in connection with the first embodiment, the luminance level of the body region in the ith tracking target frame image (hereinafter referred to as the ith luminance level) is found based on the image data of the body region in the ith tracking target frame image. The average luminance of the pixels belonging to the body region of the ith tracking target frame image can be taken as the ith luminance level. Then, the ith luminance level is taken as VAL(i). In this case, |VAL(n)−VAL(n−1)| in formula (6-6) is the difference in the luminance of the tracking target (body region) between the nth and (n−1)th tracking target frame images.

Alternatively, an average or weighted average of characteristic quantities with respect to a plurality of tracking target frame images obtained before the nth tracking target frame image may be substituted in VAL(n−1) in formula (6-6). Specifically, for example, the average of the characteristic quantities with respect to the (n−1)th and (n−2)th tracking target frame images may be substituted in VAL(n−1) in formula (6-6).

If a tracking result is obtained in which a characteristic quantity of a tracking target changes sharply, the tracking result has dubious reliability. In view of this, in the sixth calculation method, the reliability evaluation value EV_{R} is calculated based on variation of a characteristic quantity representing an image characteristic of a tracking target.

Seventh Calculation Method: A seventh calculation method will now be described. The first embodiment dealt with the following technology:

After a tracking color is set, a search range and a tracking frame are set within a tracking target frame image as a calculation target image; then, while the tracking frame is moved from one position to another within the search range, evaluation of similarity between the color of the image within the tracking frame and the tracking color is executed; thus the position of the tracking target on the tracking target frame image can be detected.

The entire region of the calculation target image is divided into small blocks (see FIG. 7), and the small blocks are classified into subject blocks or background blocks; thereby the entire region of the calculation target image can be divided into a tracking target region, which is the composite region of the subject blocks, and a background region, which is the composite region of the background blocks.

The difference between the tracking color and the color of the ith background block can be calculated as a color difference evaluation value C_{DIS}[i]. The color difference evaluation value C_{DIS}[i] takes a value of 0 or more but 1 or less.

In the seventh calculation method, by use of this color difference evaluation value C_{DIS}[i], the reliability evaluation value EV_{R} is calculated according to formula (6-7) below.

$${EV}_{R} = ( {\sum }_{i = 1}^{R} {C}_{DIS} ( i ) ) \times ( 1 - ColArea ) \qquad ( 6 \text{-} 7 )$$

The Σ in the right side of formula (6-7) denotes the summation of the color difference evaluation values of the individual background blocks belonging to a peripheral region around the tracking target in the calculation target image. A peripheral region around the tracking target in the calculation target image is, for example, the image region that remains after the tracking target region is excluded from the search range set with respect to the calculation target image, or the image region that remains after the tracking target region is excluded from an image region slightly larger or smaller than the search range, or the image region that remains after the tracking target region is excluded from the entire region of the calculation target image. Suppose now that first to Rth background blocks (where R is an integer of 2 or more) belong to the peripheral region around the tracking target. Then the reliability evaluation value EV_{R} according to formula (6-7) is the product of the sum of the color difference evaluation values C_{DIS}[1] to C_{DIS}[R] calculated with respect to the first to Rth background blocks and (1−ColArea).

ColArea represents the proportion of background blocks having the same color as, or a similar color to, the tracking color in the peripheral region. For example, if the color difference evaluation value C_{DIS}[i] is equal to or less than a predetermined threshold value, the color of the ith background block is judged to be the same as, or similar to, the tracking color, and otherwise the color of the ith background block is judged to be dissimilar to the tracking color. Suppose that R=100 and in addition that, of 1st to 100th background blocks, only the 1st to 40th background blocks are judged to have the same color as, or a similar color to, the tracking color; then ColArea is 40%.

Tracking based on color information is stable when the color of a peripheral region around the tracking target greatly differs from the tracking color, and is unstable when they are similar. Moreover, tracking based on color information is more unstable the larger the area of colors similar to the tracking color around the tracking target. This can be coped with by the reliability evaluation offered by the seventh calculation method.

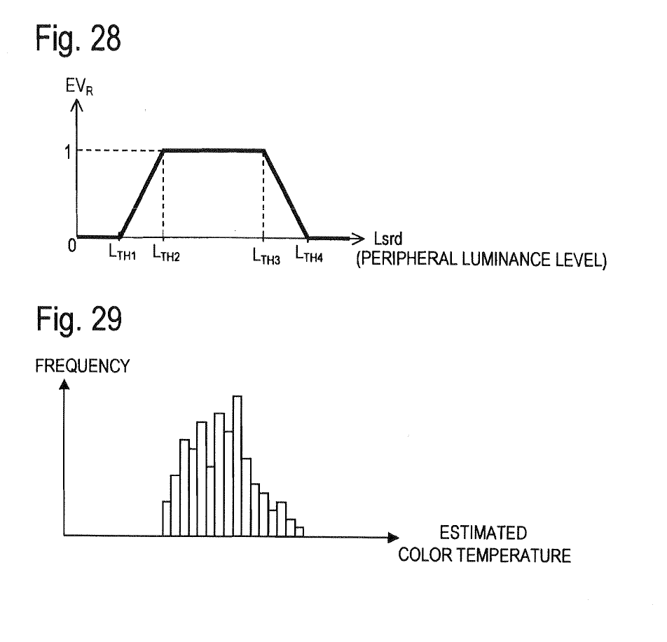

Eighth Calculation Method: An eighth calculation method will now be described. In the eighth calculation method, the reliability evaluation value EV_{R} is calculated based on the luminance around the tracking target. For example, as shown in FIG. 28, when the luminance in a peripheral region around the tracking target is extremely low or high, the reliability evaluation value EV_{R} is made small.

In the specific example shown in FIG. 28, the around-the-tracking-target luminance level Lsrd is compared with predetermined reference levels L_{TH1} to L_{TH4} and, if the inequality “Lsrd<L_{TH1}” or “L_{TH4}≦Lsrd” holds, EV_{R} is made equal to 0; if the inequality “L_{TH1}≦Lsrd<L_{TH2}” holds, EV_{R} is increased from 0 to 1 as Lsrd increases from L_{TH1} to L_{TH2}; if the inequality “L_{TH2}≦Lsrd<L_{TH3}” holds, EV_{R} is made equal to 1; and if the inequality “L_{TH3}≦Lsrd<L_{TH4}” holds, EV_{R} is decreased from 1 to 0 as Lsrd increases from L_{TH3} to L_{TH4}. Here, the reference levels L_{TH1} to L_{TH4} fulfill the inequality “0<L_{TH1}<L_{TH2}<L_{TH3}<L_{TH4}.”

The around-the-tracking-target luminance level Lsrd represents the average luminance in a peripheral region around the tracking target in a calculation target image (i.e., the average of the luminance values of the pixels belonging to the peripheral region). A peripheral region around the tracking target has a significance similar to that mentioned in the description of the seventh calculation method. A peripheral region around the tracking target may be regarded as all or part of the AE evaluation region described in connection with the third embodiment so that the around-the-tracking-target luminance level Lsrd is calculated based on the AE evaluation value (see the third embodiment) representing the luminance level of the AE evaluation region.

In tracking processing based on color information, if the luminance in a peripheral region is extremely low or high (for example, if underexposure or overexposure occurs), a slight variation in the light source causes a great variation in hue, and this makes it difficult to execute stable tracking. Such situations can be coped with by the reliability evaluation offered by the eighth calculation method.

Ninth Calculation Method: A ninth calculation method will now be described. In a case where the ninth calculation method is used, the tracking reliability evaluation portion 52 shown in FIG. 4 etc. estimates, for each tracking target frame image, the color temperature of the light source of the tracking target frame image based on the image data of the tracking target frame image (this estimation may be performed by any block other than the tracking reliability evaluation portion 52).

As a method for estimating color temperature, any known estimation method can be used. For example, just as small blocks [m, n] are set within a calculation target image (see FIG. 7), a plurality of small blocks are set within a tracking target frame image of interest, and, for each small block, based on the image data of the small block, the color of the small block is classed as either an object color with comparatively high color saturation or a light source color with comparatively low color saturation. The small blocks whose colors are classified into light source colors are referred to as light source color blocks. For each light source color block, based on the R, G, and B signals of the light source color block, the color temperature of the light source is estimated, and the average of the color temperatures estimated with respect to the individual light source color blocks can be estimated as the color temperature with respect to the tracking target frame image of interest. FIG. 29 shows an example of the distribution of the color temperatures estimated with respect to the individual tracking target frame images.

In the ninth calculation method, by use of the estimated color temperatures, the reliability evaluation value EV_{R} with respect to the calculation target image is calculated according to formula (6-9) below. When the right side of formula (6-9) is negative, however, EV_{R} is made equal to zero.

EV_{R}=1−(CTi−CTstd) (6-9)

Here, CTi represents the dispersion of the estimated color temperature with respect to a plurality of tracking target frame images obtained before the calculation target image, and CTstd represents a previously set reference dispersion.

A large CTi indicates a great variation in the color temperature of the light source during the shooting of the tracking target frame images. In tracking processing based on color information, if the color temperature of the light source varies greatly, stable tracking is difficult to execute. Such situations can be coped with by the reliability evaluation offered by the ninth calculation method.

Tenth Calculation Method: A tenth calculation method will now be described. In the tenth calculation method, the reliability evaluation value EV_{R} is calculated based on the magnitude of noise included in a tracking target frame image. Specifically, the reliability evaluation value EV_{R} with respect to a calculation target image is calculated according to formulae (6-10A) to (6-10C) below. When the right side of formula (6-10B) is negative, however, NRtgt is made equal to zero, and when the right side of formula (6-10C) is negative, NRsrd is made equal to zero.

EV_{R}=NRtgt×NRsrd (6-10A)

NRtgt=1−(σtgt/σbase) (6-10B)

NRsrd=1−(σsrd/σbase) (6-10C)

A flat portion included within the tracking target region in the calculation target image is called the first flat portion, and a flat portion included within a peripheral region around the tracking target in the calculation target image is called the second flat portion. A peripheral region around the tracking target has a significance similar to that mentioned in the description of the seventh calculation method. The symbol σtgt represents the standard deviation of the luminance values of the pixels within the first flat portion, the symbol σsrd represents the standard deviation of the luminance values of the pixels within the second flat portion, and the symbol σbase represents a previously set reference standard deviation.

What σtgt itself or its positive square root represents is the magnitude of noise included in the image within the first flat portion, or the signal-to-noise ratio of the image within the first flat portion (a similar description applies to (srd). Thus, when the magnitude of noise included in the tracking target region and/or a peripheral region is comparatively great, the value of σtgt and/or σsrd is small, and thus the reliability evaluation value EV_{R} is small.

The first flat portion can be set in the following manner. An evaluation block having a predetermined image size is set within the tracking target region in the calculation target image and, while the evaluation block is moved one pixel after another in the horizontal or vertical direction within the tracking target region, every time it is so moved, the standard deviation of the luminance values of the pixels within the evaluation block is found. Thus, a plurality of standard deviations are found. Then the position of the evaluation block corresponding to, of those standard deviations, the smallest one is identified, and the image region within the evaluation block located at that position is set as the first flat portion. The second flat portion is set in a similar manner. In the setting of the second flat portion, the evaluation block is located within a peripheral region around the tracking target.

Inclusion of noise of a great magnitude in the tracking target region and/or the peripheral region diminishes the stability of tracking. Such situations can be coped with by the reliability evaluation offered by the tenth calculation method.

As the method for calculating the reliability evaluation value EV_{R}, the first to tenth calculation methods have been described individually. It is however also possible to calculate the reliability evaluation value EV_{R} by a method realized by combining together two or more of the first to tenth calculation methods. In the first to tenth calculation methods described above, to calculate the reliability evaluation value EV_{R} with respect to one calculation target image, n_{A} tracking target frame images are used (where n_{A} is an integer of 1 or more). It is however also possible, in the first to tenth calculation methods, unless inconsistent, to perform the calculation by use of n_{B} tracking target frame images (where n_{B} is an integer of 1 or more and fulfilling n_{A}≠n_{B}).

For example, in the first calculation method as described above, to calculate the reliability evaluation value EV_{R} with respect to the frame image at time point tₙ as a calculation target image, only the image data of the frame image at time point tₙ is used, but the calculation may be performed by use of the image data of the frame images at time points tₙ and tₙ₋₁. More specifically, it is possible to calculate the reliability evaluation value EV_{R} with respect to the frame image at time point tₙ, for example, by substituting in TgtSize in formula (6-1) above the average of the extent TgtSize of the tracking target in the frame image at time point tₙ and the extent TgtSize of the tracking target in the frame image at time point tₙ₋₁.

Modifications, Variations, etc.: Unless inconsistent, the features described in connection with any of the first to sixth embodiments can be implemented in combination with the features of any other. The specific values given in the description above are merely examples, which, needless to say, may be modified to any other values. In connection with the embodiments described above, modified examples or supplementary explanations applicable to them will be given below in Notes 1 to 5. Unless inconsistent, the contents of any of these notes may be combined with the contents of any other.

Note 1: The embodiments described above deal with cases where the tracking target is a person. The tracking target, however, may be anything other than a person; for example, the tracking target may be a vehicle such as an automobile, or a mobile robot.

Note 2: In the embodiments described above, frames are taken as units, and various kinds of processing including face detection processing and tracking processing is performed on a series of frame images. Instead, fields may be taken as units, and such processing may be performed on a series of field images.

Note 3: An indication indicating the tracking reliability evaluated by the tracking reliability evaluation portion 52 may be displayed on the display portion 15. The indication is displayed on the display portion 15 along with the moving image to be displayed on the display portion 15.

Note 4: Image shooting devices according to the embodiments can be realized in hardware, or in a combination of hardware and software. In particular, the blocks shown in FIGS. 4, 15, 19, and 23 can be realized in hardware, in software, or in a combination of hardware and software. In a case where an image shooting device is built with software, a block diagram showing the part realized in software serves as a functional block diagram of that part. All or part of the calculation processing that needs to be executed may be prepared in the form of a software program so that, when the software program is executed on a program execution device (for example, a computer), all or part of the calculation processing is realized.

Note 5: In time of the playback of a moving image, a device including the blocks identified by the reference signs 51 to 54 in FIG. 4 and a device including the blocks identified by the reference signs 51, 52, and 101 to 104 in FIG. 23 each function as an image playback device. This image playback device may include any other block (such as the display portion 15) that are provided in an image shooting device. This image playback device may be realized with a device (unillustrated) that is external to an image shooting device and that can read data recorded on the recording medium 16.

What is claimed is:

1. An image shooting device comprising:
an image sensing device that, by sequential shooting, outputs a signal representing a series of shot images;
a tracking processing portion that, based on the output signal of the image sensing device, sequentially detects position of a tracking target on the series of shot images and thereby tracks the tracking target on the series of shot images;
a clipping processing portion that, for each shot image, based on the detected position, sets a clipping region in the shot image and extracts an image within the clipping region as a clipped image or outputs clipping information indicating position and extent of the clipping region; and
a tracking evaluation portion that, based on the output signal of the image sensing device, evaluates degree of reliability or ease of tracking by the tracking processing portion,
wherein the clipping processing portion varies the extent of the clipping region in accordance with the evaluated degree.

2. The image shooting device according to claim 1,
wherein the clipping processing portion makes the extent of the clipping region smaller when the degree is evaluated to be comparatively high than when the degree is evaluated to be comparatively low.

3. The image shooting device according to claim 1,
wherein the clipping processing portion sets the extent of the clipping region based on the evaluated degree and extent of the tracking target on the shot image.

4. The image shooting device according to claim 1,
wherein the tracking evaluation portion
receives one of the series of shot images as a calculation target image,
divides an entire region of the calculation target image into a tracking target region where the tracking target appears and a background region other than the tracking target region, and
evaluates the degree by comparison of an image characteristic in the tracking target region with an image characteristic in the background region.

5. An image shooting device comprising:
an image sensing device that, by sequential shooting, outputs a signal representing a series of shot images;
a tracking processing portion that, based on the output signal of the image sensing device, sequentially detects position of a tracking target on the series of shot images and thereby tracks the tracking target on the series of shot images;
an angle-of-view adjustment portion that adjusts angle of view in shooting; and
a tracking evaluation portion that, based on the output signal of the image sensing device, evaluates degree of reliability or ease of tracking by the tracking processing portion,
wherein the angle-of-view adjustment portion varies the angle of view in accordance with the evaluated degree.

6. The image shooting device according to claim 5,
wherein the angle-of-view adjustment portion adjusts the angle of view in accordance with the degree such that, when the degree is evaluated to be comparatively high, extent of the tracking target on the shot image is comparatively large and, when the degree is evaluated to be comparatively low, the extent of the tracking target on the shot image is comparatively small.

7. The image shooting device according to claim 6,
wherein the angle-of-view adjustment portion sets the angle of view based on the evaluated degree and the extent of the tracking target on the shot image.

8. The image shooting device according to claim 5,
wherein the tracking evaluation portion
receives one of the series of shot images as a calculation target image,
divides an entire region of the calculation target image into a tracking target region where the tracking target appears and a background region other than the tracking target region, and
evaluates the degree by comparison of an image characteristic in the tracking target region with an image characteristic in the background region.

9. An image playback device comprising:
an image acquisition portion that, by reading from a recording portion an image signal obtained by sequential shooting of a subject, acquires a series of input images based on the image signal;
a tracking processing portion that, based on the image signal of the series of input images, sequentially detects position of a tracking target on the series of input images and thereby tracks the tracking target on the series of input images;
a clipping processing portion that, for each input image, based on the detected position, sets a clipping region in the input image and extracts an image within the clipping region as a clipped image; and
a tracking evaluation portion that, based on the image signal of the series of input images, evaluates degree of reliability or ease of tracking by the tracking processing portion,
the image playback device outputting an image signal of a series of clipped images to a display portion or to outside,
wherein the clipping processing portion varies the extent of the clipping region in accordance with the evaluated degree.

10. An image shooting device comprising:
an image sensing device that, by sequential shooting, outputs a signal representing a series of shot images;
a tracking processing portion that, based on the output signal of the image sensing device, sequentially detects position of a tracking target on the series of shot images and thereby tracks the tracking target on the series of shot images;
a region setting portion that, based on the detected position, sets an evaluation value collection region within each shot image;
an acquisition condition control portion that, based on an image signal within the evaluation value collection region in each shot image, controls a condition for acquisition of the series of shot images; and
a tracking evaluation portion that, based on the output signal of the image sensing device, evaluates degree of reliability or ease of tracking by the tracking processing portion,
wherein the region setting portion varies extent of the evaluation value collection region in accordance with the evaluated degree.

11. An image playback device comprising:
an image acquisition portion that, by reading from a recording portion an image signal obtained by sequential shooting of a subject, acquires a series of input images based on the image signal;
a tracking processing portion that, based on the image signal of the series of input images, sequentially detects position of a tracking target on the series of input images and thereby tracks the tracking target on the series of input images;
a region setting portion that, based on the detected position, sets an evaluation value collection region within each input image;
an output image generation portion that, based on an image signal within the evaluation value collection region of each input image, retouches the series of input images to generate a series of output images; and
a tracking evaluation portion that, based on the image signal of the series of input images, evaluates degree of reliability or ease of tracking by the tracking processing portion,
the image playback device outputting an image signal of the series of output images to a display portion or to outside,
wherein the region setting portion varies extent of the evaluation value collection region in accordance with the evaluated degree.
